(19) United States
(12) Patent Application Publication
(10) Pub. No.: US 2023/0167323 A1
(43) Pub. Date: Jun. 1, 2023

(54) Non-White Textile Printing Ink Jet Ink Composition, Ink Set, And Recording Method

(71) Applicant: SEIKO EPSON CORPORATION, Tokyo (JP)

(72) Inventors: Kazuto AOKI, Shiojiri (JP); Shugo HATTORI, Shiojiri (JP); Haruka SATO, Shiojiri (JP); Masakazu OHASHI, Shiojiri (JP)

(21) Appl. No.: 18/071,074

(22) Filed: Nov. 29, 2022

(30) Foreign Application Priority Data
Nov. 30, 2021 (JP) 2021-194367

(51) Int. Cl. C09D 11/322; C09D 11/324; C09D 11/107; C09D 11/102; C09D 11/40

(52) U.S. Cl. CPC C09D 11/322; C09D 11/324; C09D 11/107; C09D 11/102; C09D 11/40

(57) ABSTRACT

A non-white textile printing ink jet ink composition according to the present disclosure contains a pigment, a resin particle, an acetylene-based surfactant having an HLB value of 6 or more and 10 or less, and water, wherein a content of the acetylene-based surfactant is 0.5% by mass or more and 2.0% by mass or less relative to a total amount of the ink composition, and the ink composition is used for a fabric having water absorbency evaluated using a method described below is 1 or more,
method:
a test fabric cut into 2 cm square is mounted on a water surface in a glass bottle which has a volume of 50 mL and in which 30 mL of pure water is introduced so that a height from a bottom to the water surface is 4 cm, a fabric surface being set to be parallel to the water surface, and a time elapsed from the fabric being mounted until a portion of the fabric reaching the bottom of the glass bottle is denoted as water absorbency in seconds.

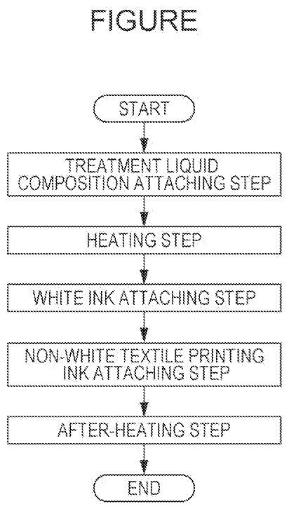

The present application is based on, and claims priority from JP Application Serial Number 2021-194367, filed Nov. 30, 2021, the disclosure of which is hereby incorporated by reference herein in its entirety.

### BACKGROUND

### 1. Technical Field

The present disclosure relates to a non-white textile printing ink jet ink composition, an ink set, and a recording method.

### 2. Related Art

An application of an ink jet recording method to not only recording of an image on a medium such as paper but also textile printing on a fabric has been attempted, and various ink compositions and recording methods for ink jet textile printing have also been researched. For example, JP-A-2017-186702 discloses a method in which, regarding textile printing on a fabric, after a treatment liquid composition is attached to the fabric, a white ink jet ink composition is attached, and, thereafter, a non-white ink jet ink composition is attached to the white ink jet ink composition.

However, regarding textile printing on the fabric, since water absorbency of the material changes in accordance with the fabric, color developability may be poor, bleeding (bleeding between colors) may occur, and washing fastness may be poor. Further, when continuous printing is performed with respect to textile printing by using an ink jet method, printing omission and irregular printing occur, and there is a poor stability problem in continuous printing.

Regarding the light-colored fabric, textile printing is performed by directly attaching a non-white ink, that is, a color ink, to the fabric without attaching a treatment liquid composition to the fabric in advance. Therefore, such a problem occurs more significantly.

### SUMMARY

According to an aspect of the present disclosure, a non-white textile printing ink jet ink composition contains a pigment, a resin particle, an acetylene-based surfactant having an HLB value of 6 or more and 10 or less, and water, wherein a content of the acetylene-based surfactant is 0.5% by mass or more and 2.0% by mass or less relative to a total amount of the ink composition, and the ink composition is used for a fabric having water absorbency evaluated using a method described below is 1 or more,
method:
a test fabric cut into 2 cm square is mounted on a water surface in a glass bottle which has a volume of 50 mL and in which 30 mL of pure water is introduced so that a height from a bottom to the water surface is 4 cm, a fabric surface being set to be parallel to the water surface, and a time elapsed from the fabric being mounted until a portion of the fabric reaching the bottom of the glass bottle is denoted as water absorbency in seconds.

### BRIEF DESCRIPTION OF THE DRAWING

FIGURE is a flow chart illustrating an example of a textile printing recording method according to the present embodiment.

### DESCRIPTION OF EXEMPLARY EMBODIMENTS

The embodiment according to the present disclosure (hereafter referred to as “the present embodiment”) will be described below in detail. However, the present disclosure is not limited to this and can be variously modified within the bounds of not departing from the scope of the disclosure.

### 1. Non-White Textile Printing Ink Jet Ink Composition

A non-white textile printing ink jet ink composition according to the present embodiment (hereafter also referred to as “ink composition” or “non-white textile printing ink”) contains a pigment, a resin particle, an acetylene-based surfactant having an HLB value of 6 or more and 10 or less, and water, wherein a content of the acetylene-based surfactant is 0.5% by mass or more and 2.0% by mass or less relative to a total amount of the ink composition, and the ink composition is used for a fabric having water absorbency evaluated using a method described below is 1 or more,
method:
a test fabric cut into 2 cm square is mounted on a water surface in a glass bottle which has a volume of 50 mL and in which 30 mL of pure water is introduced so that a height from a bottom to the water surface is 4 cm, a fabric surface being set to be parallel to the water surface, and a time elapsed from the fabric being mounted until a portion of the fabric reaching the bottom of the glass bottle is denoted as water absorbency in seconds.

According to the present embodiment, a non-white textile printing ink jet ink composition that has favorable color developability and washing fastness which are hardly influenced by the water absorbency of the fabric, that can suppress bleeding (bleeding between colors) from occurring, and that can be stably continuously printed during textile printing by using an ink jet method can be obtained. In addition, according to the present embodiment, favorable rubbing fastness is also provided.

Although the specific reasons for such excellent effects being obtained due to the present embodiment are not certain, the present inventors conjecture as described below.

That is, in general, fabrics, in particular, cotton fabrics include those having low water absorbency and those having high water absorbency. Regarding the fabric having low water absorbency, since the permeability of the ink composition is high, bleeding between colors readily occurs. As a result, color developability is poor, and bleeding tends to occur. In addition, regarding the fabric having high water absorbency, the permeability of the ink composition is low, and the ink composition remains in the vicinity of the surface of the fabric so that the washing fastness and the rubbing fastness tend to be deteriorated. In consideration of such water absorbency of the fabric, a measure of containing a silicone-based or fluorine-based surfactant in the ink composition is conceived. However, since these surfactants have excessively low surface tension with respect to the fabric, the ink composition containing such a surfactant tends to have poor ejection stability. Therefore, it is difficult to stably continuously performing printing with respect to textile printing by using an ink jet method.

On the other hand, the non-white textile printing ink jet ink composition according to the present embodiment contains a pigment, a resin particle, water, and, in addition, a specific amount of acetylene-based surfactant having an HLB value of 6 or more and 10 or less. According to such a specific ink composition, the ink composition favorably permeates the fabric regardless of the water absorbency of the fabric. Consequently, since bleeding between colors hardly occurs and since the ink composition hardly remains in the vicinity of the surface of the fabric, it is conjectured that favorable color developability, washing fastness, and rubbing fastness can be realized. In this regard, the ink composition contains a specific amount of an acetylene-based surfactant so as to have favorable surface tension with respect to the fabric and to have favorable ejection stability. Therefore, it is conjectured that stable continuous printing can be performed with respect to textile printing by using an ink jet method. However, the reason is not limited to this.

Next, each component contained in the ink composition will be described, and the fabric will be described later.

### 1.1 Pigment

The ink composition according to the present embodiment contains a pigment which is not white (hereafter also referred to as “non-white pigment”).

In the present specification, the non-white pigment is a pigment having a color other than white. Examples of such a non-white pigment may include cyan, yellow, magenta, and black color pigments.

Herein, in the present specification, “white” in the expression of “white pigment” or “white ink jet ink composition” (hereafter also referred to as “white ink”) denotes a color which has L* of 100 in CIELAB and a color which has L* of 60 or more and 100 or less and each of a* and b* of ±10 or less. In this regard, CIELAB can be measured using, for example, a fluorescent spectrodensitometer (FD-7 (trade name), KONICA MINOLTA, INC.).

The non-white pigment has excellent storage stability such as light resistance, weather resistance, and gas resistance and may be an organic pigment from such a viewpoint.

Specific examples of the pigment include azo pigments, such as insoluble azo pigments, condensed azo pigments, azo lakes, and chelate azo pigments, polycyclic pigments, such as phthalocyanine pigments, perylene and perinone pigments, anthraquinone pigments, quinacridone pigments, dioxane pigments, thioindigo pigments, isoindolinone pigments, and quinophthalone pigments, dye chelates, dye lakes, nitro pigments, nitroso pigments, aniline black, daylight fluorescent pigments, and carbon black. One type of the above-described pigments may be used alone, or at least two types may be used in combination. Further, glitter pigments may be used as the non-white pigment.

Specific examples of the pigment include the following.

Examples of the black pigment include No. 2300, No. 900, MCF88, No. 33, No. 40, No. 45, No. 52, MA7, MA8, MA100, No. 2200B, and the like (all are produced by Mitsubishi Chemical Corporation), Raven 5750, Raven 5250, Raven 5000, Raven 3500, Raven 1255, Raven 700, and the like (all are produced by Carbon Columbia), Regal 400R, Regal 330R, Regal 660R, Mogul L, Monarch 700, Monarch 800, Monarch 880, Monarch 900, Monarch 1000, Monarch 1100, Monarch 1300, Monarch 1400, and the like (all are produced by CABOT JAPAN K. K.), and Color Black FW1, Color Black FW2, Color Black FW2V, Color Black FW18, Color Black FW200, Color Black 5150, Color Black 5160, Color Black 5170, Printex 35, Printex U, Printex V, Printex 140U, Special Black 6, Special Black 5, Special Black 4A, and Special Black 4 (all are produced by Degussa).

In this regard, in the present embodiment, self-dispersion type black pigments surface-treated by oxidation treatment with hypohalous acid and/or hypohalite, oxidation treatment with ozone, or oxidation treatment with persulfuric acid and/or persulfate may be self-dispersion type pigments of the non-white pigments from the viewpoint of a high degree of color development. In addition, commercially available products can also be used as the self-dispersion type pigment of the black ink composition, and examples may include MICROJET CW1 (produced by Orient Chemical Industries, Ltd.).

Examples of the yellow pigment include C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, and 180.

Examples of the magenta pigment include C.I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48(Ca), 48(Mn), 57(Ca), 57:1, 88, 112, 114, 122, 123, 144, 146, 149, 150, 166, 168, 170, 171, 175, 176, 177, 178, 179, 184, 185, 187, 202, 209, 219, 224, and 245, and C.I. Pigment Violet 19, 23, 32, 33, 36, 38, 43, and 50.

Examples of the cyan pigment include C.I. Pigment Blue 1, 2, 3, 15, 15:1, 15:2, 15:3, 15:34, 15:4, 16, 18, 22, 25, 60, 65, and 66, and C.I. Vat Blue 4 and 60.

Examples of the pigment other than magenta, cyan, and yellow include C.I. Pigment Green 7 and 10, C.I. Pigment Brown 3, 5, 25, and 26, and C.I. Pigment Orange 1, 2, 5, 7, 13, 14, 15, 16, 24, 34, 36, 38, 40, 43, and 63.

Examples of the pearl pigment include pigments having iridescent luster or interference luster, such as titanium-dioxide-covered mica, fish scale guanine, and bismuth oxychloride.

Examples of the metallic pigment include particles of simple substance of silver, gold, platinum, nickel, chromium, tin, zinc, indium, titanium, and copper or alloys of these.

It is favorable that the non-white pigment can be stably dispersed or dissolved in a dispersing medium, and dispersion may be performed using a dispersing agent as the situation demands. Examples of the dispersing agent include resin dispersing agents, and the dispersing agent is selected from those capable of making the dispersion stability of the non-white pigment in the ink composition to become favorable. In this regard, the non-white pigment may be used as a self-dispersion type pigment by the pigment surface being oxidized or sulfonated with, for example, ozone, hypochlorous acid, or fuming sulfuric acid so as to modify the surface of the pigment particle.

Examples of the resin dispersing agent include water-soluble resins, for example, (meth)acrylic resins and salts thereof, such as poly(meth)acrylic acids, (meth)acrylic acid-acrylonitrile copolymers, (meth)acrylic acid-(meth)acrylic acid ester copolymers, vinyl acetate-(meth)acrylic acid ester copolymers, vinyl acetate-(meth)acrylic acid copolymers, and vinylnaphthalene-(meth)acrylic acid copolymers; styrene-based resins and salts thereof, such as styrene-(meth)acrylic acid copolymers, styrene-(meth)acrylic acid-(meth)acrylic acid ester copolymers, styrene-α-methylstyrene-(meth)acrylic acid copolymers, styrene-α-methylstyrene-(meth)acrylic acid-(meth)acrylic acid ester copolymers, styrene-maleic acid copolymers, and styrene-maleic anhydride copolymers; urethane resins which are polymer compounds (resins) having a urethane bond resulting from a reaction between an isocyanate group and a hydroxy group, which may be straight-chain-like and/or branched, and which is not limited to having a crosslinked structure and salts thereof; polyvinyl alcohols; vinylnaphthalene-maleic acid copolymers and salts thereof; vinyl acetate-maleic acid ester copolymers and salts thereof; and vinyl acetate-crotonic acid copolymers and salts thereof. Of these, copolymers of a monomer having a hydrophobic functional group and a monomer having a hydrophilic functional group and polymers composed of a monomer having both a hydrophobic functional group and a hydrophilic functional group may be adopted. Regarding the form of the copolymer, any form of a random copolymer, a block copolymer, an alternating copolymer, and a graft copolymer can be used.

Examples of the commercially available product of the styrene-based dispersing agent include X-200, X-1, X-205, X-220, and X-228 (produced by SEIKO PMC CORPORATION), Nopco Sperse (registered trademark) 6100 and 6110 (produced by San Nopco Limited), Joncryl (registered trademark) 67, 586, 611, 678, 680, 682, and 819 (produced by BASF), DISPERBYK (registered trademark)-190 (produced by BYK Japan KK), and N-EA137, N-EA157, N-EA167, N-EA177, N-EA197D, N-EA207D, and E-EN10 (produced by Dai-ichi Kogyo Seiyaku Co., Ltd.).

Examples of the commercially available product of the acrylic resin dispersing agent include DISPERBYK-187, BYK-190, BYK-191, BYK-194N, and BYK-199 (produced by BYK Japan KK), and ARON (registered trademark) A-210, A6114, AS-1100, AS-1800, A-30SL, A-7250, and CL-2 (produced by TOAGOSEI Co., Ltd.).

Examples of the commercially available product of the urethane-based resin dispersing agent include DISPERBYK-182, BYK-183, BYK-184, and BYK-185 (produced by BYK Japan KK), TEGO (registered trademark) Disperse710 (produced by Evonic Tego Chemi), and Borchi (registered trademark) Gen1350 (produced by OMG Borschers).

In this regard, the commercially available products are listed above. However, the dispersing agent may be obtained through synthesis by using a common method.

One type of the dispersing agents may be used alone, or at least two types may be used in combination. A total content of the dispersing agents in the ink composition is preferably 0.1 parts by mass or more and 30 parts by mass or less, more preferably 0.5 parts by mass or more and 25 parts by mass or less, still more preferably 1 part by mass or more and 20 parts by mass or less, and further preferably 1.5 parts by mass or more and 15 parts by mass or less relative to 100 parts by mass of the non-white pigment. The content of the dispersing agent being 0.1 parts by mass or more relative to 100 parts by mass of the non-white pigment enables the dispersion stability of the non-white pigment to be further enhanced. In addition, the content of the dispersing agent being 30 parts by mass or less relative to 100 parts by mass of the non-white pigment enables the viscosity of the resulting dispersing agent to be further reduced.

The weight average molecular weight of the dispersing agent is further preferably 500 or more. Using such a resin dispersing agent as the dispersing agent enables smell to be reduced and enables the dispersion stability of the non-white pigment to be more favorable. In this regard, when the dispersing agent is used, the non-white pigment serving as a base particle is not limited to being surface-treated. In addition, in the present specification, the weight average molecular weight denotes a value in terms of polystyrene measured using gel permeation chromatography (GPC).

The content of the non-white pigment is preferably 0.3% by mass or more and 20% by mass or less and more preferably 0.5% by mass or more and 15% by mass or less relative to a total amount of the ink composition from the viewpoint of favorable and well-balanced color developability and ejection stability. Further, 1% by mass or more and 10% by mass or less is preferable, and 2% by mass or more and 7% by mass or less is more preferable.

### 1.2 Resin Particle

The ink composition according to the present embodiment contains a resin particle.

The resin particle can further improve the adhesiveness and the like of an image by using the ink composition attached to a recording medium. Examples of the resin particle include resin particles containing urethane-based resins, acrylic resins (including styrene-acrylic resins), fluorene-based resins, polyolefin-based resins, rosin-modified resins, terpene-based resins, polyester-based resins, polyamide-based resins, epoxy-based resins, vinyl chloride-based resins, vinyl chloride-vinyl acetate copolymers, ethylene-vinyl acetate-based resins, or the like. Of these, urethane-based resins, acrylic resins, polyolefin-based resins, and polyester-based resins may be used. These resin particles are frequently handled in an emulsion form but may be supplied in a powder state. In this regard, one type of the resin particles may be used alone, or at least two types may be used in combination.

The urethane-based resin is a generic name for resins having a urethane bond. Examples of the urethane-based resin include polyether-type urethane resins having an ether bond in addition to the urethane bond in the main chain, polyester-type urethane resins having an ester bond in the main chain, and polycarbonate-type urethane resins having a carbonate bond in the main chain. In addition, commercially available products may be used as the urethane resin, and examples include SUPERFLEX (registered trademark) 460, 460s, 840, and E-4000 (produced by Dai-ichi Kogyo Seiyaku Co., Ltd.), RESAMINE (registered trademark) D-1060, D-2020, D-4080, D-4200, D-6300, and D-6455 (produced by Dainichiseika Color & Chemicals Mfg. Co., Ltd.), TAKELAC (registered trademark) WS-6021 and W-512-A-6 (produced by Mitsui Chemicals, Inc.), Sancure (registered trademark) 2710 (produced by LUBRIZOL), and PERMARIN (registered trademark) UA-150 (produced by Sanyo Chemical Industries, Ltd.).

The acrylic resin is a generic name for polymers obtained by polymerization in which at least an acrylic monomer such as a (meth)acrylic acid or a (meth)acrylic acid ester serves as one component. Examples of the acrylic resin include resins obtained from acrylic monomers and copolymers of acrylic monomers and other monomers. More specific examples include acryl-vinyl-based resins which are copolymers of acrylic monomers and vinyl-based monomers. In this regard, examples of the vinyl-based monomer include styrene.

Regarding the acrylic monomer, for example, acrylamide, acrylonitrile, and the like can also be used. Commercially available products may also be used as the resin emulsions by using an acrylic resin as a raw material, and examples include FK-854 (produced by CHUORIKA KOUGYO Co., Ltd.), Mowinyl (registered trademark) 952B and 718A (produced by The Nippon Synthetic Chemical Industry Co., Ltd.), and Nipol (registered trademark) LX852 and LX874 (produced by ZEON Corporation).

In this regard, in the present specification, the acrylic resin may be styrene-acrylic resins described below. In addition, in the present specification, an expression “(meth)acryl” means at least one of acryl and methacryl.

The styrene-acrylic resin is a copolymer obtained from a styrene monomer and a (meth)acrylic monomer, and examples include styrene-acrylic acid copolymers, styrene-methacrylic acid copolymers, styrene-methacrylic acid-acrylic acid ester copolymers, styrene-α-methylstyrene-acrylic acid copolymers, and styrene-α-methylstyrene-acrylic acid-acrylic acid ester copolymers. Commercially available products can also be used as the acrylic resin, and examples include Joncryl (registered trademark) 62J, 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, and 7610 (produced by BASF), Mowinyl (registered trademark) 966A and 975N (produced by The Nippon Synthetic Chemical Industry Co., Ltd.), and Vinyblan (registered trademark) 2586 (produced by Nisshin Chemical Industry Co., Ltd.).

The polyolefin-based resin includes an olefin such as ethylene, propylene, or butylene in the structure skeleton, and a known resin can be appropriately selected and used. Commercially available products can be used as the olefin resin, and, for example, Arrowbase (registered trademark) CB-1200 or CD-1200 (produced by UNITIKA LTD.) may be used.

In this regard, the commercially available products are listed above. However, the resin particle may be obtained through synthesis by using a common method.

The content of the resin particle as a solid content is preferably 0.1% by mass or more and 20% by mass or less, more preferably 1% by mass or more and 15% by mass or less, and further preferably 2% by mass or more and 10% by mass or less relative to a total amount of the ink composition.

### 1.3. Acetylene-Based Surfactant Having HLB Value of 6 or More and 10 or Less

The ink composition according to the present embodiment includes an acetylene-based surfactant having an HLB value of 6 or more and 10 or less. The content of the acetylene-based surfactant is 0.5% by mass or more and 2.0% by mass or less relative to a total amount of the ink composition.

In the present specification, the hydrophile-lipophile balance (HLB) value is a value for evaluating the hydrophilicity of a compound, which is proposed by Davies et al., and is a numerical value determined based on the Davies' method specified in the literature “J. T. Davies and E. K. Ridial, “Interface Phenomena” 2nd ed. Academic Press, New York 1963”. The HLB value is calculated by Formula (i) below.

HLB value=7+Σ[1]−Σ[2] (i)

(In Formula (i), [1] represents the number of hydrophilic groups, and [2] represents the number of hydrophobic groups.)

The HLB value is preferably 6 or more and 9 or less since an ink composition that is hardly influenced by the water absorbency of the fabric, that has more favorable color developability and washing fastness, that has more excellent rubbing fastness, and that can further suppresses bleeding (bleeding between colors) from occurring is obtained. In addition, the HLB value is preferably 7 or more and 8 or less since an ink composition that has more favorable washing fastness, that has more excellent rubbing fastness, that can further suppresses bleeding (bleeding between colors) from occurring, and that has more favorable color developability with respect to the fabric having poor water absorbency is obtained.

One type of the acetylene-based surfactants may be used alone, or at least two types may be used in combination, provided that the HLB value is 6 or more and 10 or less. In the present embodiment, for example, an acetylene-based surfactant having an HLB value of more than 10 and an acetylene-based surfactant having an HLB value of less than 6 may be used in combination so that an acetylene-based surfactant having an HLB value of 6 or more and 10 or less is contained in the ink composition. In this regard, a surfactant other than the acetylene-based surfactant may be contained provided that the effects of the present disclosure are exerted.

The acetylene-based surfactant may be an acetylene-glycol-based surfactant since an ink composition capable of stably performing continuous printing regardless of the water absorbency of the fabric during textile printing by using an ink jet method is obtained. Regarding the acetylene-glycol-based surfactant, acetylene glycols denoted by Formula (1) below having an HLB value of 6 or more and 10 or less and acetylene glycol ethylene oxide adducts denoted by Formula (2) below having an HLB value of 6 or more and 10 or less are more favorable. Regarding the acetylene-glycol-based surfactant, acetylene glycol ethylene oxide adducts denoted by Formula (2) below are further favorably included.

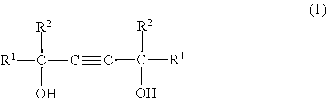

In Formula (1), each of R¹ and R² represents an alkyl group having a carbon number of 1 or more and 5 or less. The alkyl group having a carbon number of 1 or more and 5 or less may have a straight-chain structure or a branched structure. Specific examples of such an alkyl group include a methyl group, an ethyl group, a n-propyl group, an isopropyl group, a n-butyl group, an isobutyl group, a sec-butyl group, a tert-butyl group, a pentyl group, an isopentyl group, and a neopentyl group. R¹ and R² may be the same or may differ from each other.

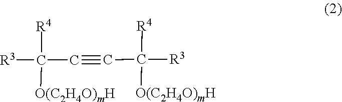

In Formula (2), each of R³ and R⁴ represents an alkyl group having a carbon number of 1 or more and 5 or less, each of m and n represents an integer of 0 or more and 25 or less, and m+n is 1 or more and 40 or less. The alkyl group having a carbon number of 1 or more and 5 or less may have a straight-chain structure or a branched structure. Specific examples of such an alkyl group include a methyl group, an ethyl group, a n-propyl group, an isopropyl group, a n-butyl group, an isobutyl group, a sec-butyl group, a tert-butyl group, a pentyl group, an isopentyl group, and a neopentyl group. R³ and R⁴ may be the same or may differ from each other. In this regard, m+n represents the number of moles of ethylene oxide added, and m+n has to be 1 or more and 40 or less, is preferably 10 or more and 30 or less, and more preferably 15 or more and 25 or less. When m+n is 40 or less, the surface tension with respect to the fabric can be suppressed from increasing, more favorable ejection stability is obtained, and continuous printing can be more stably performed with respect to textile printing by using an ink jet method.

Examples of the acetylene glycol denoted by Formula (1) include 2,5,8,11-tetramethyl-6-dodecyne-5,8-diol, 5,8-dimethyl-6-dodecyne-5,8-diol, 2,4,7,9-tetramethyl-5-decyne-4,7-diol, 4,7-dimethyl-5-decyne-4,7-diol, 2,3,6,7-tetramethyl-4-octyne-3,6-diol, 3,6-dimethyl-4-octyne-3,6-diol, 3,6-diethyl-4-octyne-3,6-diol, and 2,5-dimethyl-3-hexyne-2,5-diol.

Examples of the acetylene glycol ethylene oxide adducts denoted by Formula (2) include ethylene oxide adducts of the compounds listed as specific examples of the acetylene glycols denoted by Formula (1).

Commercially available products may be used as the acetylene-based surfactant, and examples include Surfynol (registered trademark) 440 (HLB value: 8), Surfynol SE (HLB value: 6), Surfynol SE-F (HLB value: 6), Surfynol 61 (HLB value: 6), Surfynol 2502 (HLB value: 8), and Surfynol TG (HLB value: 9) (all are produced by Nisshin Chemical Industry Co., Ltd.); OLFIN (registered trademark) PD-002W (HLB value: 10) and OLFIN E1004 (HLB value: 7 or more and 9 or less) (all are trade names, produced by Nisshin Chemical Industry Co., Ltd.); and Acetylenol (registered trademark) E40 (HLB value: 10) (trade name, produced by Kawaken Fine Chemicals Co., Ltd.). One type of these may be used alone, or at least two types may be used in combination.

The content of the acetylene-based surfactant is preferably 0.7% by mass or more and 1.5% by mass or less relative to a total amount of the ink composition since an ink composition that is hardly influenced by the water absorbency of the fabric, that has more favorable color developability and washing fastness, that has more excellent rubbing fastness, and that can further suppresses bleeding (bleeding between colors) from occurring is obtained.

### 1.4. Water

The ink composition according to the present embodiment contains water.

The ink composition is a water-based ink. The water-based ink is a composition containing water as one of main solvent components. Being a water-based ink enables an environmental load to be reduced and, for example, enables recording with less smell to be performed.

The water is a component that is vaporized and scattered by drying. The water may be pure water or ultrapure water, for example, ion-exchanged water, ultrafiltration water, reverse osmosis water, and distilled water, from which ionic impurities are removed as much as possible. In this regard, using of water sterilized by ultraviolet irradiation, addition of hydrogen peroxide, or the like is favorable since mold and bacteria can be suppressed from growing when the ink is stored for a long time.

The content of the water is preferably 45% by mass or more, more preferably 50% by mass or more and 98% by mass or less, and further preferably 55% by mass or more and 95% by mass or less relative to a total amount of the ink composition.

### 1.5. Other Components

The ink composition according to the present embodiment may contain components, such as an organic solvent, a surfactant other than the acetylene-based surfactant having an HLB value of 6 or more and 10 or less, a wax, an additive, a preservative, a rust inhibitor, a chelating agent, a viscosity adjuster, an antioxidant, and a fungicide, in addition to the non-white pigment, the resin particle, the acetylene-based surfactant having an HLB value of 6 or more and 10 or less, and the water provided that the effects of the present disclosure are exerted.

### Organic Solvent

The ink composition may contain an organic solvent. The organic solvent may have water solubility. Examples of the function of the organic solvent include an improvement of wettability of the ink composition with respect to the recording medium and an enhancement of moisture retention of the ink composition. In addition, the organic solvent also functions as a permeating agent.

Examples of the organic solvent include esters, alkylene glycol ethers, cyclic esters, nitrogen-containing solvents, and polyhydric alcohols. Examples of the nitrogen-containing solvent include cyclic amides and non-cyclic amides. Examples of the non-cyclic amide include alkoxyalkylamides.

On the other hand, it is particularly favorable that the organic solvent not contain 2-pyrrolidone, diethylene glycol, and ethylene glycol since a recorded material that satisfies the standards of the Global Organic Textile Standard (GOTS) certification and the OEKO-TEX certification can be favorably produced. From the same viewpoint, a total content of these organic solvents is preferably 0.05% by mass or less relative to a total amount of the ink composition, and the lower limit is particularly preferably 0% by mass.

Examples of the ester include glycol monoacetates, such as ethylene glycol monomethyl ether acetate, ethylene glycol monoethyl ether acetate, ethylene glycol monobutyl ether acetate, diethylene glycol monomethyl ether acetate, diethylene glycol monoethyl ether acetate, diethylene glycol monobutyl ether acetate, propylene glycol monomethyl ether acetate, dipropylene glycol monomethyl ether acetate, and methoxybutyl acetate, and glycol diesters, such as ethylene glycol diacetate, diethylene glycol diacetate, propylene glycol diacetate, dipropylene glycol diacetate, ethylene glycol acetate propionate, ethylene glycol acetate butylate, diethylene glycol acetate butylate, diethylene glycol acetate propionate, diethylene glycol acetate butylate, propylene glycol acetate propionate, propylene glycol acetate butylate, dipropylene glycol acetate butylate, and dipropylene glycol acetate propionate.

The alkylene glycol ether has to be a monoether or a diether of an alkylene glycol and may be an alkyl ether. Specific examples include alkylene glycol monoalkyl ethers, such as ethylene glycol monomethyl ether, ethylene glycol monoethyl ether, ethylene glycol monoisopropyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, triethylene glycol monobutyl ether, tetraethylene glycol monomethyl ether, tetraethylene glycol monoethyl ether, tetraethylene glycol monobutyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, dipropylene glycol monobutyl ether, and tripropylene glycol monobutyl ether, and alkylene glycol dialkyl ethers, such as ethylene glycol dimethyl ether, ethylene glycol diethyl ether, ethylene glycol dibutyl ether, diethylene glycol dimethyl ether, diethylene glycol diethyl ether, diethylene glycol dibutyl ether, diethylene glycol methylethyl ether, diethylene glycol methylbutyl ether, triethylene glycol dimethyl ether, triethylene glycol diethyl ether, triethylene glycol dibutyl ether, triethylene glycol methylbutyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, dipropylene glycol diethyl ether, and tripropylene glycol dimethyl ether.

Regarding the above-described alkylene glycols, a diether rather than a monoether tends to readily dissolve or swell the resin particle in the ink and is favorable from the viewpoint of improving the rubbing resistance of a formed image.

Examples of the cyclic ester include cyclic esters (lactones), such as β-propiolactone, γ-butyrolactone, δ-valerolactone, ε-caprolactone, β-butyrolactone, β-valerolactone, γ-valerolactone, β-hexanolactone, γ-hexanolactone, δ-hexanolactone, β-heptanolactone, γ-heptanolactone, δ-heptanolactone, ε-heptanolactone, γ-octanolactone, δ-octanolactone, ε-octanolactone, δ-nonalactone, ε-nonalactone, and ε-decanolactone and these compounds in which hydrogen of a methylene group adjacent to a carbonyl group thereof is substituted with an alkyl group having a carbon number of 1 or more and 4 or less.

Examples of the alkoxyalkylamide include 3-methoxy-N,N-dimethylpropionamide, 3-methoxy-N,N-diethylpropionamide, 3-methoxy-N,N-methylethylpropionamide, 3-ethoxy-N,N-dimethylpropionamide, 3-ethoxy-N,N-diethylpropionamide, 3-ethoxy-N,N-methylethylpropionamide, 3-n-butoxy-N,N-dimethylpropionamide, 3-n-butoxy-N,N-diethylpropionamide, 3-n-butoxy-N,N-methylethylpropionamide, 3-n-propoxy-N,N-dimethylpropionamide, 3-n-propoxy-N,N-diethylpropionamide, 3-n-propoxy-N,N-methylethylpropionamide, 3-iso-propoxy-N,N-dimethylpropionamide, 3-iso-propoxy-N,N-diethylpropionamide, 3-iso-propoxy-N,N-methylethylpropionamide, 3-tert-butoxy-N,N-dimethylpropionamide, 3-tert-butoxy-N,N-diethylpropionamide, and 3-tert-butoxy-N,N-methylethylpropionamide.

Examples of the cyclic amide include lactams. Specific examples include pyrrolidones, such as 2-pyrrolidone, 1-methyl-2-pyrrolidone, 1-ethyl-2-pyrrolidone, 1-propyl-2-pyrrolidone, and 1-butyl-2-pyrrolidone.

Examples of the polyhydric alcohol include 1,2-alkanediols (alkanediols, such as ethylene glycol, propylene glycol (also known as propane-1,2-diol), 1,2-butanediol, 1,2-pentanediol, 1,2-hexanediol, 1,2-heptanediol, and 1,2-octanediol) and polyhydric alcohols (polyols) other than 1,2-alkanediols (for example, diethylene glycol, dipropylene glycol, triethylene glycol, 1,3-propanediol, 1,3-butanediol (also known as 1,3-butylene glycol), 1,4-butanediol, 1,5-pentanediol, 1,6-hexanediol, 2-ethyl-2-methyl-1,3-propanediol, 2-methyl-2-propyl-1,3-propanediol, 2-methyl-1,3-propanediol, 2,2-dimethyl-1,3-propanediol, 3-methyl-1,3-butanediol, 2-ethyl-1,3-hexanediol, 3-methyl-1,5-pentanediol, 2-methylpentane-2,4-diol, trimethylolpropane, and glycerin).

Polyhydric alcohols can be divided into alkanediols and polyols. The alkanediol is a diol of an alkane having a carbon number of 5 or more. The carbon number of the alkane is preferably 5 or more and 15 or less, more preferably 6 or more and 10 or less, and further preferably 6 or more and 8 or less. The polyhydric alcohols may be 1,2-alkanediols.

The polyol is a polyol of an alkane having a carbon number of 4 or less or an intermolecular condensate between hydroxy groups of the polyol of an alkane having a carbon number of 4 or less. The carbon number of the alkane is preferably 2 or more and 3 or less. The number of hydroxy groups in the molecule of the polyol is 2 or more, preferably 5 or less, and more preferably 3 or less. When the polyol is the above-described intermolecular condensate, the number of intermolecular condensation is 2 or more, preferably 4 or less, and more preferably 3 or less. One type of the polyhydric alcohols may be used alone, or at least two types may be used in combination.

The alkanediols and the polyols can function as mainly a permeating solvent and/or a humectant. The alkanediols tend to have strong properties of the permeating solvent, and the polyols tend to have strong properties of the humectant. Examples of the organic solvent having strong properties of the humectant include glycerin.

When the ink composition contains the organic solvent, one type of the organic solvents may be used alone, or at least two types may be used in combination.

The content of the organic solvent is, for example, 5% by mass or more and 50% by mass or less, preferably 10% by mass or more and 45% by mass or less, more preferably 15% by mass or more and 40% by mass or less, and further preferably 20% by mass or more and 40% by mass or less relative to a total amount of the ink composition. Surfactant other than acetylene-based surfactant having HLB value of 6 or more and 10 or less

The ink composition may contain a surfactant other than the acetylene-based surfactant having an HLB value of 6 or more and 10 or less provided that the effects of the present disclosure are exerted. Examples of such a surfactant include silicone-based surfactants and fluorine-based surfactants.

### Wax

The ink composition may contain a wax.

Examples of the component constituting the wax include plant-animal-based waxes, such as carnauba wax, candellila wax, beeswax, rice wax, and lanoline; petroleum-based waxes, such as paraffin wax, microcrystalline wax, polyethylene wax, oxidized polyethylene wax, and petrolatum; mineral-based waxes, such as montan wax and ozokerite; synthetic waxes, such as carbon wax, Hoechst wax, polyolefin wax, and stearamide; and natural-synthetic wax emulsions and compound waxes, such as α-olefin-maleic anhydride copolymers. One type of these may be used alone, or at least two types may be used in combination.

### Additives

The ink composition may contain ureas, amines, saccharide, and the like as additives.

Examples of the urea include urea, ethylene urea, tetramethylurea, thiourea, and 1,3-dimethyl imidazolidinone and betaines (trimethylglycine, triethylglycine, tripropylglycine, triisopropylglycine, N,N,N-trimethylalanine, N,N,N-triethylalanine, N,N,N-triisopropylalanine, N,N,N-trimethylmethylalanine, carnitine, acetylcarnitine, and the like).

Examples of the amine include diethanolamine, triethanolamine, and triisopropanolamine. The ureas and the amines may function as a pH adjuster.

Examples of the saccharide include glucose, mannose, fructose, ribose, xylose, arabinose, galactose, aldonic acid, glucitol (sorbitol), maltose, cellobiose, lactose, sucrose, trehalose, and maltotriose.

### Others

The ink composition may further contain components such as a preservative, a rust inhibitor, a chelating agent, a viscosity adjuster, an antioxidant, and a fungicide.

### 1.6. Physical Properties and Production of Ink Composition

The viscosity of the ink composition at 20° C. is set to be preferably 1.5 mPa·s or more and 15 mPa·s or less, more preferably 1.5 mPa·s or more and 7 mPa·s or less, and further preferably 1.5 mPa·s or more and 5.5 mPa·s or less.

The upper limit of the surface tension of the ink composition at 25° C. is preferably 40 mN/m or less, more preferably 38 mN/m or less, further preferably 35 mN/m or less, still further preferably 32 mN/m or less, and particularly preferably 30 mN/m or less from the viewpoint of making the wet-spreadability with respect to the recording medium appropriate. In addition, from the same viewpoint, the lower limit of the surface tension is preferably 15 mN/m or more, more preferably 20 mN/m or more, further preferably 25 mN/m or more, and still further preferably 27 mN/m or more. In this regard, in the present specification, the surface tension can be measured as a surface tension when a platinum plate is wetted with the composition at normal temperature and normal pressure by using Surface Tensiometer CBVP-Z (trade name, produced by Kyowa Interface Science Co., Ltd.). The specific measuring method may refer to the example.

The surface tension of the ink composition being within the above-described range enables the ejection stability and the initial filling performance in ink jet recording to be favorable.

### 1.7. Method for Producing Ink Composition

The ink composition can be prepared by mixing the non-white pigment, the resin particle, the acetylene-based surfactant having an HLB value of 6 or more and 10 or less, the water, and, as the situation demands, other components in any order, and removing impurities and foreign matters by performing filtration or the like as the situation demands. Regarding the method for mixing the components, a method in which the components are successively added to a container provided with an agitator such as a mechanical stirrer or a magnetic stirrer and agitation and mixing are performed is used. Examples of the filtration method include centrifugal filtration and filter filtration.

### 2. White Ink Jet Ink Composition

The white ink jet ink composition (hereafter also referred to as “white ink”) contains a white pigment, a resin particle, a silicone-based surfactant having an HLB value of 10 or more and 14 or less, and water.

### 2.1. White Pigment

The white ink according to the present embodiment contains a white pigment.

Examples of the white pigment include metal compounds, such as metal oxides, barium sulfate, and calcium carbonate. Examples of the metal oxide include titanium dioxide, zinc oxide, silica, alumina, and magnesium oxide. In this regard, a particle having a hollow structure may be used for the white pigment, and known particles may be used as the particle having a hollow structure.

Of these, typical example of the white pigment is titanium dioxide, and examples include TIPAQUE CR-50-2, CR-57, CR-58-2, CR-60-2, CR-60-3, CR-Super-70, CR-90-2, CR-95, CR953, PC-3, PF-690, PF-691, PF-699, PF-711, PF-728, PF-736, PF-737, PF-739, PF-740, PF-742, R-980, and UT-771 (all are produced by ISHIHARA SANGYO KAISHA, Ltd.) and C.I. Pigment White 6.

Titanium dioxide being selected as the white pigment enables the color developability of a white image to be further enhanced. In this regard, one type of the white pigments may be used alone, or at least two types may be used in combination.

The content of the white pigment as a solid content is preferably 0.5% by mass or more and 20.0% by mass or less, more preferably 1.0% by mass or more and 20.0% by mass or less, further preferably 3.0% by mass or more and 15.0% by mass or less, and still further preferably 7.0% by mass or more and 13.0% by mass or less relative to a total amount of the white ink. The content of the white pigment being within the above-described range enables an image having more sufficient visibility to be obtained.

It is favorable that the white pigment can be stably dispersed in a dispersing medium, and, therefore, the white pigment may be dispersed by using a dispersing agent. Examples of the dispersing agent include dispersing agents akin to those used for non-white coloring materials of the above-described non-white textile printing ink.

### 2.2. Resin Particle

The white ink according to the present embodiment contains a resin particle.

Examples of the resin particle include the resin particle akin to that contained in the above-described non-white textile printing ink.

The content of the resin particle as a solid content is preferably 0.1% by mass or more and 20% by mass or less, more preferably 1% by mass or more and 15% by mass or less, and further preferably 2% by mass or more and 10% by mass or less relative to a total amount of the white ink.

### 2.3. Silicone-Based Surfactant Having HLB Value of 10 or More and 14 or Less

The white ink according to the present embodiment contains a silicone-based surfactant having an HLB value of 10 or more and 14 or less.

The HLB value is preferably 10 or more and 13 or less and more preferably 11 or more and 12 or less since more favorable color developability, washing fastness, and rubbing fastness are provided.

One type of the silicone-based surfactants may be used alone, or at least two types may be used in combination provided that the HLB value is 10 or more and 14 or less. In the present embodiment, for example, a silicone-based surfactant having an HLB value of more than 14 and a silicone-based surfactant having an HLB value of less than 10 may be used in combination so that the white ink contains a silicone-based surfactant having an HLB value of 10 or more and 14 or less. In this regard, the white ink may contain a surfactant other than the silicone-based surfactant provided that the effects of the present disclosure are exerted.

Examples of the silicone-based surfactant include side-chain-modified polydimethylsiloxanes, both-end-modified polydimethylsiloxanes, one-end-modified polydimethylsiloxanes, and side-chain- and both-end-modified polydimethylsiloxanes, which have an HLB value of 10 or more and 14 or less.

Commercially available products may be used as such a silicone-based surfactant and are available from BYK Japan KK, Shin-Etsu Chemical Co., Ltd., Dow Corning Toray Silicone Co., Ltd., Nihon Emulsion Co., Ltd., and Kyoeisha Chemical Co., Ltd. Examples include BYK-348 (HLB value: 11) produced by BYK Japan KK and KF-6004 (HLB value: 9) produced by Shin-Etsu Chemical Co., Ltd.

The content of the silicone-based surfactant is preferably 0.1% by mass or more and 2.0% by mass or less, more preferably 0.4% by mass or more and 1.5% by mass or less, and further preferably 0.5% by mass or more and 1.0% by mass or less relative to a total amount of the white ink since still more favorable color developability, washing fastness, and rubbing fastness are provided.

### 2.4. Water

The white ink according to the present embodiment contains water.

The water may refer to the water contained in the non-white textile printing ink above.

The content of the water is preferably 45% by mass or more, more preferably 50% by mass or more and 98% by mass or less, and further preferably 55% by mass or more and 95% by mass or less relative to a total amount of the white ink.

### 2.5. Other Components

The white ink according to the present embodiment may contain components, such as an organic solvent, a surfactant other than the silicone-based surfactant having an HLB value of 10 or more and 14 or less, a wax, an additive, a preservative, a rust inhibitor, a chelating agent, a viscosity adjuster, an antioxidant, and a fungicide, in addition to the white pigment, the resin particle, the silicone-based surfactant having an HLB value of 10 or more and 14 or less, and the water provided that the effects of the present disclosure are exerted. These components may refer to the components contained in the above-described non-white textile printing ink.

### 2.6. Physical Properties of White Ink

The viscosity of the white ink at 20° C. is set to be preferably 1.5 mPa·s or more and 15 mPa·s or less, more preferably 1.5 mPa·s or more and 7 mPa·s or less, and further preferably 1.5 mPa·s or more and 5.5 mPa·s or less.

The upper limit of the surface tension of the white ink at 25° C. is preferably 40 mN/m or less, more preferably 38 mN/m or less, further preferably 35 mN/m or less, still further preferably 32 mN/m or less, and particularly preferably 30 mN/m or less from the viewpoint of making the wet-spreadability with respect to the recording medium appropriate. In addition, from the same viewpoint, the lower limit of the surface tension is preferably 15 mN/m or more, more preferably 20 mN/m or more, further preferably 25 mN/m or more, and still further preferably 27 mN/m or more.

The surface tension of the white ink being within the above-described range enables the ejection stability and the initial filling performance in ink jet recording to be more favorable.

### 2.7. Method for Producing White Ink

The method for producing the white ink may refer to the method for producing the non-white textile printing ink above.

### 3. Ink Set

An ink set includes the non-white textile printing ink and the white ink.

The ink set according to the present embodiment can be used for a fabric described later. In the present embodiment, a treatment liquid composition is attached, in advance, to the fabric described later so as to obtain the fabric to which the treatment liquid composition is attached. Thereafter, the fabric to which the treatment liquid composition is attached is textile-printed with the white ink, and the textile printing surface is textile-printed with the non-white textile printing ink so that a recorded material having favorable color developability, washing fastness, and rubbing fastness can be simply and conveniently obtained. In addition, continuous printing can be stably performed with respect to textile printing by using an ink jet method. In this regard, the treatment liquid composition will be described later.

The white ink according to the present embodiment contains a silicone-based surfactant having an HLB value of 10 or more and 14 or less. In addition, the non-white textile printing ink according to the present embodiment contains a specific amount of acetylene-based surfactant having an HLB value of 6 or more and 10 or less. Consequently, an underlying layer can be favorably formed of the white ink with respect to the fabric to which the treatment liquid composition is attached, and a color layer can be favorably formed of the non-white ink on the underlying layer. As a result, since the ink can be suppressed from permeating the fabric and since the color layer can remain on the underlying layer of the fabric surface, an influence of the color of just the fabric is reduced, and a recorded material having favorable color developability, washing fastness, and rubbing fastness can be obtained. In addition, continuous printing can be stably performed with respect to textile printing by using an ink jet method.

### 3.1. Treatment Liquid Composition

The treatment liquid composition contains a cationic compound, a resin particle, a surfactant, and water.

### 3.1.1. Cationic Compound

The treatment liquid composition contains a cationic compound.

The cationic compound is a compound that releases a cation or that has a cation. The cationic compound has a function of the components such as the pigment and the resin particle. The degree of aggregation of the pigment, the resin particle, and the like due to the cationic compound changes and can be adjusted in accordance with the respective types of the cationic compound, the pigment, and the resin particle. For example, the color developability can be enhanced, the fixability of the resin particle can be enhanced, and/or the ink viscosity can be increased in accordance with such aggregation.

Examples of the cationic compound include metal salts and cationic organic compounds. For example, cation polymers, cationic surfactants, and the like can be used as the cationic organic compound. The metal salt may be a polyvalent metal salt, and the cationic organic compound may be a cation polymer. In addition, organic acids may be used from the viewpoint of releasing a proton.

The metal salt may be a polyvalent metal salt, but a metal salt other than the polyvalent metal salt can be used. Of the cationic compounds, at least one type of the metal salts may be used from the viewpoint of readily causing cation responsiveness of the pigment and the resin particle. One type of the cationic compounds may be used alone, or at least two types may be used in combination.

The polyvalent metal salt is a compound composed of a divalent or higher metal ion and an anion. Examples of the divalent or higher metal ion include ions of calcium, magnesium, copper, nickel, zinc, barium, aluminum, titanium, strontium, chromium, cobalt, iron, and the like. Of the metal ions constituting the polyvalent metal salts, at least one of a calcium ion and a magnesium ion is favorable from the viewpoint of excellent capability of aggregating the ink component.

The anion constituting the polyvalent metal salt is an inorganic ion or an organic ion. That is, the polyvalent metal salt is composed of an inorganic ion or an organic ion and a divalent or higher metal ion. Examples of the inorganic ion include an chlorine ion, a bromine ion, an iodine ion, a nitric acid ion, a sulfuric acid ion, and a hydroxide ion. Examples of the organic ion include organic acid ions, and more specific examples include a carboxylic acid ion.

Specific examples of the polyvalent metal salt include calcium carbonate such as calcium carbonate heavy and precipitated calcium carbonate light, calcium nitrate, calcium chloride, calcium sulfate, magnesium sulfate, calcium hydroxide, magnesium chloride, magnesium carbonate, barium sulfate, barium chloride, zinc carbonate, zinc sulfide, aluminum silicate, calcium silicate, magnesium silicate, copper nitrate, calcium acetate, magnesium acetate, and aluminum acetate. One type of these polyvalent metal salts may be used alone, or at least two types may be used in combination. Of these, at least one of magnesium sulfate, calcium nitrate, and calcium chloride is favorable since sufficient solubility in water can be ensured and since traces due to the treatment liquid composition are reduced, and calcium nitrate is more favorable. In this regard, these metal salts may have hydrated water in a raw-material form.

Examples of the metal salt other than the polyvalent metal salt include monovalent metal salts such as sodium salts and potassium salts, and more specific examples include sodium sulfate and potassium sulfate.

Favorable examples of the organic acids include poly(meth)acrylic acids, acetic acid, glycolic acid, malonic acid, malic acid, maleic acid, ascorbic acid, succinic acid, glutaric acid, fumaric acid, citric acid, tartaric acid, lactic acid, sulfonic acid, orthophosphoric acid, pyrrolidonecarboxylic acid, pyronecarboxylic acid, pyrrolecarboxylic acid, furanecarboxylic acid, pyridinecarboxylic acid, coumalic acid, thiophenecarboxylic acid, and nicotinic acid or derivatives of these compounds and salts of these. One type of the organic acids may be used alone, or at least two types may be used in combination. Organic acid salts that are metal salts are included in the above-described metal salts.

Favorable examples of the inorganic acid include sulfuric acid, chloric acid, nitric acid, and phosphoric acid or salts of these. One type of the inorganic acids may be used alone, or at least two types may be used in combination. Inorganic acid salts that are metal salts are included in the above-described metal salts.

Examples of the cationic polymer that is a polymer having a cationic property include cationic urethane-based resins, cationic olefin-based resins, and cationic amine-based resins. The cationic polymer is favorably soluble in water.

Commercially available products can be used as the cationic urethane-based resin, and examples of the usable product include HYDRAN CP-7010, CP-7020, CP-7030, CP-7040, CP-7050, CP-7060, and CP-7610 (trade name, produced by DIC Corporation), SUPERFLEX 600, 610, 620, 630, 640, and 650 (trade name, produced by Dai-ichi Kogyo Seiyaku Co., Ltd.), and Urethane Emulsion WBR-2120C and WBR-2122C (trade name, produced by Taisei Fine Chemical Co., Ltd.).

The cationic olefin resin includes an olefin such as ethylene or propylene in a structure skeleton, and a known resin can be appropriately selected and used. In this regard, the cationic olefin resin may be dispersed in a solution containing water, an organic solvent, or the like so as to take on an emulsion form. Commercially available products can be used as the cationic olefin resin, and examples include Arrowbase CB-1200 and CD-1200 (trade name, produced by UNITIKA LTD.).

The cationic amine-based resin has to include an amino group in the structure, and a known resin can be appropriately selected and used. Examples include polyamine-based resins, polyamide-based resins, and polyallyamine-based resins. The polyamine-based resin is a resin including an amino group in the main skeleton of the resin. The polyamide-based resin is a resin including an amide group in the main skeleton of the resin. The polyallylamine-based resin is a resin including a structure derived from an allyl group in the main skeleton of the resin.

In this regard, Examples of the cationic polyamine-based resin include UNISENCE KHE103L (hexamethylenediamine/epichlorohydrin resin, pH of 1% aqueous solution of substantially 5.0, viscosity of 20 mPa·s or more and 50 mPa·s or less, aqueous solution having a solid concentration of 50% by mass) and UNISENCE KHE104L (dimethylamine/epichlorohydrin resin, pH of 1% aqueous solution of substantially 7.0, viscosity of 1 mPa·s or more and 10 mPa·s or less, aqueous solution having a solid concentration of 20% by mass) produced by SENKA corporation. Further, specific examples of the commercially available product of the cationic polyamine-based resin include FL-14 (produced by SNF), ARAFIX 100, 251S, 255, and 255LOX (produced by ARAKAWA CHEMICAL INDUSTRIES LTD.), DK-6810, 6853, and 6885; and WS-4010, 4011, 4020, 4024, 4027, and 4030 (produced by SEIKO PMC CORPORATION), PAPYOGEN P-105 (produced by SENKA corporation), Sumirez Resin 650 (30), 675A, 6615, and SLX-1 (produced by Taoka Chemical Co., Ltd.), Catiomaster (registered trademark) PD-1, 7, 30, A, PDT-2, PE-10, PE-30, DT-EH, EPA-SK01, and TMHMDA-E (produced by Yokkaich Chemical Company Limited), and JETFIX 36N, 38A, and 5052 (Satoda Chemical Industrial Co., Ltd.).

Examples of the polyallylamine resin include polyallylamine chloric acid salts, polyallylamine amidesulfuric acid salts, allylamine chloric acid salt-diallylamine chloric acid salt copolymers, allylamine acetic acid salt-diallylamine acetic acid salt copolymers, allylamine chloric acid salt-dimethylallylamine chloric acid salt copolymers, allylamine-dimethylallylamine copolymers, polydiallylamine chloric acid salts, polymethyldiallylamine chloric acid salts, polymethyldiallylamine amidesulfuric acid salts, polymethyldiallylamine acetic acid salts, polydiallyldimethylammonium chloride, diallylamine acetic acid salt-sulfur dioxide copolymers, diallylmethylethylammonium ethylsulfate-sulfur dioxide copolymers, methyldiallylamine chloric acid salt-sulfur dioxide copolymers, diallyldimethylammonium chloride-sulfur dioxide copolymers, and diallyldimethylammonium chloride-acrylamide copolymers.

One type of these cationic compounds may be used alone, or at least two types may be used in combination. In this regard, of these cationic compounds, at least one of the polyvalent metal salt, the organic acid, and the cationic polymer being selected enables an image having more favorable color developability to be formed since the function of aggregating dispersed particles becomes more favorable.

The content of the cationic compound is preferably 0.1% by mass or more and 40% by mass or less, more preferably 1% by mass or more and 20% by mass or less, and further preferably 2% by mass or more and 10% by mass or less relative to a total amount of the treatment liquid composition.

### 3.1.2. Resin Particle

The treatment liquid composition contains a resin particle.

For example, a resin emulsion can be used as the resin particle. Examples of the resin used as the resin particle include urethane-based resins, addition-polymerization-based resins, fluororesins, and natural resins. Examples of the addition-polymerization-based resin include monopolymers or copolymers of (meth)acrylic acids, (meth)acrylic acid esters, acrylonitrile, cyanoacrylate, acrylamide, olefins, styrene, silicone, rosin, terpene, epoxy, polyesters, vinyl acetate, vinyl chloride, vinyl alcohol, vinyl ethers, vinylpyrrolidone, vinylpyridine, vinylcarbazole, vinylimidazole, and vinylidene chloride.

Examples of the commercially available products of the resin emulsion include Vinyblan (registered trademark) 150, 603, 745, and 1245L (produced by Nisshin Chemical Industry Co., Ltd.), DANFIX (registered trademark) MM11 (produced by Nisshin Chemical Industry Co., Ltd.), SENKAANTIFRIC (registered trademark) CX-2 (produced by SENKA corporation), Mowinyl (registered trademark) 966A (produced by The Nippon Synthetic Chemical Industry Co., Ltd.), Microgel (registered trademark) E-1002 and E-5002 (produced by Nippon Paint Co., Ltd.), VONCOAT (registered trademark) 4001 and 5454 (produced by DIC Corporation), SAE1014 (produced by ZEON Corporation), Saivinol (registered trademark) SK-200 (produced by SAIDEN CHEMICAL INDUSTRY CO., LTD.), Joncryl (registered trademark) 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, and 7610 (produced by BASF), NK Binder R-5HN (produced by SHIN-NAKAMURA CHEMICAL CO., LTD.), Sancure 2710 (produced by Lubrizol Japan Limited), PERMARIN (registered trademark) UA-150 (produced by Sanyo Chemical Industries, Ltd.), SUPERFLEX (registered trademark) 460, 470, 610, and 700 (produced by Dai-ichi Kogyo Seiyaku Co., Ltd.), NeoRez (registered trademark) R-9660, R-9637, and R-940 (produced by Kusumoto Chemicals, Ltd.), ADEKA BONTIGHTER (registered trademark) HUX-380 and 290K (produced by ADEKA Corporation), and TAKELAC (registered trademark) W-605, W-635, and WS-6021 (produced by Mitsui Chemicals, Inc.).

The content of the resin particle is preferably 0.01% by mass or more and 10% by mass or less, more preferably 0.05% by mass or more and 5% by mass or less, and further preferably 0.1% by mass or more and 3% by mass or less relative to a total amount of the treatment liquid composition.

### 3.1.3. Surfactant

The treatment liquid composition contains a surfactant.

Examples of the surfactant include acetylene-glycol-based surfactants, silicone-based surfactants, and fluorine-based surfactants.

Examples of the acetylene-glycol-based surfactant include Surfynol (registered trademark) 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA, and DF110D (produced by Nisshin Chemical Industry Co., Ltd.), OLFIN (registered trademark) B, Y, P, A, STG, SPC, E1004, E1010, PD-001, PD-002W, PD-003, PD-004, EXP. 4001, EXP. 4036, EXP. 4051, AF-103, AF-104, AK-02, SK-14, and AE-3 (produced by Nisshin Chemical Industry Co., Ltd.), and Acetylenol (registered trademark) E00, E00P, E40, and E100 (Kawaken Fine Chemicals Co., Ltd.).

Examples of the silicone-based surfactant include polysiloxane-based compounds such as polyether-modified organosiloxanes. Examples of the commercially available product of the polyether-modified organosiloxane include BYK-306, BYK-307, BYK-333, BYK-341, BYK-345, BYK-346, and BYK-348 (produced by BYK Japan KK), KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (produced by Shin-Etsu Chemical Co., Ltd.).

Examples of the fluorine-based surfactant include fluorine-modified polymers. Examples include BYK-340 (produced by BYK Japan KK).

The content of the surfactant is preferably 0.01% by mass or more and 10.0% by mass or less, more preferably 0.05% by mass or more and 5.0% by mass or less, and further preferably 0.07% by mass or more and 1.0% by mass or less relative to a total amount of the treatment liquid composition.

### 3.1.4. Water

The treatment liquid composition contains water.

The water may refer to the water contained in the above-described non-white textile printing ink.

The content of the water is preferably 45% by mass or more, more preferably 50% by mass or more and 98% by mass or less, and further preferably 55% by mass or more and 95% by mass or less relative to a total amount of the treatment liquid composition.

### 3.1.5. Other Components

The treatment liquid composition may contain various additives, such as a dissolution auxiliary, a viscosity adjuster, a pH adjuster, an antioxidant, a preservative, a fungicide, a corrosion inhibitor, and a chelating agent.

One type of the additives may be used alone, or at least two types may be used in combination.

The content of each additive is 0.01% by mass or more and 5.0% by mass or less relative to a total amount of the treatment liquid composition.

### 3.1.6. Method for Preparing Treatment Liquid Composition

The treatment liquid composition can be prepared by mixing the components in any order, and removing impurities and foreign matters by performing filtration or the like as the situation demands. Regarding the method for mixing the components, a method in which the components are successively added to a container provided with an agitator such as a mechanical stirrer or a magnetic stirrer and agitation and mixing are performed is used. Examples of the filtration method include centrifugal filtration and filter filtration.

### 4. Fabric

The fabric according to the present embodiment has water absorbency evaluated using a method described below of 1 or more. In this regard, a specific evaluation method may refer to the example,
method:
a test fabric cut into 2 cm square is mounted on a water surface in a glass bottle which has a volume of 50 mL and in which 30 mL of pure water is introduced so that a height from a bottom to the water surface is 4 cm, a fabric surface being set to be parallel to the water surface, and a time elapsed from the fabric being mounted until a portion of the fabric reaching the bottom of the glass bottle is denoted as water absorbency in seconds.

The water absorbency of the fabric is preferably 3 or more, more preferably 5 or more, and further preferably 7 or more since more favorable color developability and washing fastness are provided, more excellent rubbing fastness is provided, and bleeding (bleeding between colors) is further suppressed from occurring.

Regarding the light-colored fabric, textile printing is performed by directly attaching a non-white ink, that is, a color ink, to the fabric without attaching a treatment liquid composition to the fabric in advance. The ink composition according to the present embodiment has favorable color developability and washing fastness regardless of the water absorbency of the fabric, has excellent rubbing fastness, can suppress bleeding (bleeding between colors) from occurring, can be stably continuously printed during textile printing by using an ink jet method, and, therefore, can be more favorably used for the light-colored fabric to which the treatment liquid composition is not attached. In the present specification, the light-colored fabric denotes a fabric which has L* of 75 or more in CIELAB, and a dense-colored fabric denotes a fabric which has L* of less than 75 in CIELAB.

According to the ink composition of the present embodiment, textile printing can be favorably performed with respect to a fabric to which the treatment liquid composition is not attached in advance, and a recoded material that has favorable color developability and washing fastness, that has excellent rubbing fastness, and that can favorably suppress bleeding (bleeding between colors) from occurring can be obtained. In addition, regarding such a fabric, continuous printing can be stably performed with respect to textile printing by using an ink jet method. In the present specification, the fabric to which the treatment liquid composition is not attached denotes a fabric not containing a cationic compound. Specifically, the amount of the cationic compound attached to the fabric is 0.02 g/cm² or less. In this regard, the lower limit of the amount of attachment is 0.00 g/cm².

The fabric has to have water absorbency evaluated using a method described above of 1 or more and usually includes fiber. Examples of the fiber include natural fibers such as cotton, hemp, wool, and silk which have water absorbency of 1 or more; synthetic fibers such as polypropylenes, polyesters, acetates, triacetates, polyamides, and polyurethanes which have water absorbency of 1 or more; and biodegradable fibers such as polylactic acid fibers which have water absorbency of 1 or more. The fiber may be mixed-spun fibers of these.

The fiber in the fabric is favorably cotton due to having favorable color developability and washing fastness, having excellent rubbing fastness, being capable of suppressing bleeding (bleeding between colors) from occurring, and, in addition, being capable of stably performing continuous printing with respect to textile printing by using an ink jet method.

Examples of the form of the fabric include textile, knit, nonwoven fabric, cloth, and clothing and other accessories. Examples of the clothing and other accessories include T-shirts after sewing, handkerchiefs, scarves, towels, carrier bags, bags made of cloth, curtains, sheets, bed covers, and furniture such as wallpaper; and cloths before or after cutting as components before sewing. Examples of the form of these include long materials rolled into a roll-like shape, materials cut into a predetermined size, and materials in a product shape.

The mass per unit area of the fabric is favorably 1.0 oz or more and 10.0 oz or less. The mass per unit area of the fabric being within such a range enables more favorable recording to be performed.

The fabric may be a fabric colored with a dye in advance provided that the water absorbency is 1 or more. Examples of the dye for coloring the fabric in advance include water-soluble dyes such as acid dyes and basic dyes; disperse dyes in which a dispersing agent is used in combination; reactive dyes, and solvent dyes. When a cotton fabric is used as the fabric, the disperse dye or the reactive dye which is suitable for coloring the cotton is favorably used, and the disperse dye is more favorable.

### 5. Ink Jet Recording Method

The ink jet recording method according to the present embodiment is performed using an ink composition. Specifically, the ink jet recording method includes a step of attaching the ink composition to the fabric having a water absorbency of 1 or more by using an ink jet method in which the ink composition is ejected from an ink jet head. The ink jet method being adopted enables a dyed portion with a fine pattern to be readily and reliably formed. In addition, application to various fabrics can be performed, and favorable textile printing can be performed. Such a textile printing method by using an ink jet method can perform favorable textile printing on even a thick cloth so that color difference between the front and the back is reduced. In this regard, performing recording on the fabric by using the ink composition enables a recorded material having favorable color developability and washing fastness and excellent rubbing fastness to be simply and conveniently obtained. In addition, continuous printing can be stably performed with respect to textile printing by using an ink jet method.

In the step of attaching the ink composition to the fabric, the maximum amount of the ink composition attached to the fabric is preferably 50 mg/cm² or more and 200 mg/cm² or less and more preferably 80 mg/cm² or more and 150 mg/cm² or less. When the maximum amount of attachment is within the above-described range, the color developability becomes more favorable. In addition, the washing fastness and the rubbing fastness also become excellent, and aggregation variations tend not to be considerable.

### 5.1. Ink Jet Recording Apparatus

There is no particular limitation regarding the ink jet recording apparatus used for the textile printing method provided that at least an ink storing member for storing the ink composition and a recording head coupled thereto are included and that the ink composition can be ejected from the recording head so as to form an image on the fabric. In this regard, the ink jet recording apparatus of either a serial type or a line type can be used. The ink jet recording apparatus of such a type is provided with the recording head, and ink composition droplets having a predetermined volume are intermittently ejected from nozzle holes of the recording head at predetermined timings while a positional relationship between the fabric and the recording head is relatively changed. Consequently, a predetermined transfer image can be formed by attaching the ink composition to the fabric.

In general, in the serial-type ink jet recording apparatus, the transport direction of the fabric serving as a recording medium intersects the direction of reciprocating action of the recording head, and the positional relationship between the fabric and the recording head is relatively changed in accordance with the combination of the reciprocating action of the recording head and the transporting action of the fabric. In such an instance, in general, a plurality of nozzle holes are arranged in the recording head, and a line of the nozzle holes, that is, a nozzle line, is formed in the transport direction of the fabric. In this regard, a plurality of nozzle lines may be formed in the recording head in accordance with the type and the number of the ink composition.

In general, in the line-type ink jet recording apparatus, the recording head does not perform a reciprocating action, and the position of the fabric relative to the position of the recording head is changed due to transfer of the fabric serving as the recording medium so that the positional relationship between the fabric and the recording head is relatively changed. In such an instance, in general, a plurality of nozzle holes are arranged in the recording head, and a nozzle line is formed in the direction intersecting the transport direction of the fabric.

### 5.2. Other Steps

Regarding the recording method, as the situation demands, the fabric to which the ink composition is attached may be heated. Consequently, a recorded material having more favorable color developability and washing fastness and excellent rubbing fastness can be obtained.

Examples of the heating method include a heat press method, a normal-pressure steam method, a high-pressure steam method, and a Thermofix method. In this regard, examples of the heat source for heating include warm air, infrared rays, and microwaves.

During heating, the surface temperature of the heated fabric is preferably 60° C. or higher and 180° C. or lower. The surface temperature being within the above-described range enables damages to the ink jet head and the fabric to be reduced, and, in addition, the ink readily uniformly wet-spreads on the fabric and readily permeates. In this regard, the surface temperature can be measured using, for example, a noncontact thermometer (trade name “IT2-80”, produced by KEYENCE CORPORATION).

The heating time is preferably, for example, 5 sec or more and 5 min or less. The heating time being within the above-described range enables damages to the ink jet head and the fabric to be reduced and enables the fabric to be sufficiently heated.

### 5.3. Recording Method by Using Ink Set

In the present embodiment, for example, recording may be performed using an ink set with respect to a dense-colored fabric. Such a recording method may include a white ink attaching step of ejecting and attaching a white ink to the fabric and a non-white textile printing ink attaching step of attaching a non-white textile printing ink to a region to which the white ink is attached. In this regard, it is more favorable that the non-white textile printing ink attaching step be performed without performing a drying step after the white ink attaching step. It is further favorable that the recording method include a treatment liquid composition attaching step, a heating step, a white ink attaching step, a non-white textile printing ink attaching step, and an after-heating step as illustrated in FIGURE. According to the recording method including such steps, a recorded material having favorable color developability, washing fastness, and rubbing fastness can be obtained. In addition, continuous printing can be stably performed.

### 5.3.1. White Ink Attaching Step

The white ink attaching step may be performed by any system provided that a form in which the white ink is attached while a recording head is made to scan the fabric is adopted. Consequently, a small amount of and a many types of printing can be efficiently performed using a small apparatus.

### 5.3.2. Non-White Textile Printing Ink Attaching Step

The non-white textile printing ink attaching step may be performed by any system provided that a form in which the non-white textile printing ink is attached while a recording head is made to scan the fabric is adopted. Consequently, a small amount of and a many types of printing can be efficiently performed using a small apparatus.

In the non-white textile printing ink attaching step, the non-white textile printing ink is attached to a region to which the white ink is attached. That is, in the non-white textile printing ink attaching step, the non-white textile printing ink is attached over the region to which the white ink is attached. Consequently, the color developability of the non-white image becomes further favorable due to a white image masking the background. In addition, when the fabric is colored, the visibility of a formed image is made to be more favorable. Further, in the present embodiment, since the non-white textile printing ink containing a specific amount of acetylene-based surfactant having an HLB value of 6 or more and 10 or less is attached to the region to which the white ink containing the silicone-based surfactant having an HLB value of 10 or more and 14 or less is attached, a recorded material having favorable color developability, washing fastness, and rubbing fastness can be obtained. In addition, continuous printing can be stably performed with respect to textile printing by using an ink jet method.

In the non-white textile printing ink attaching step, the non-white textile printing ink may be attached to the fabric by being ejected from the recording head to which a nozzle that ejected the white ink belongs or may be ejected from a recording head other than the recording head to which a nozzle that ejected the white ink belongs.

The present step may be performed using the same apparatus as the ink jet recording apparatus for performing the white ink attaching step. In such an instance, recording head is adjusted so that the non-white textile printing ink is ejected from a nozzle different from the nozzle from which the white ink is ejected.

The non-white textile printing ink attaching step may be performed without performing a drying step after the white ink attaching step. “Without performing a drying step” means that operations of intentional heating, blowing, decompression, and the like are not performed. More specifically, after the white ink attaching step, the non-white textile printing ink attaching step is performed without a temperature environment being set to be 35° C. or higher, preferably 30° C. or higher, and more preferably 25° C. or higher. Regarding the recording method, an ink set being used enables an image having favorable color developability, washing fastness, and rubbing fastness to be formed even when the non-white textile printing ink attaching step is started without performing a drying step after the white ink attaching step is completed. Since continuous printing can be stably performed with respect to textile printing by using an ink jet method in accordance with the ink composition, an image having favorable color developability, washing fastness, and rubbing fastness can be formed on the fabric at higher speed.

### 5.3.3. Time Interval of Each Step

Regarding the Recording Method, the Non-White textile printing ink attaching step may be started within 1 min after the white ink attaching step is completed. Regarding the recording method, an ink set being used enables an image having favorable color developability, washing fastness, and rubbing fastness to be formed even when the non-white textile printing ink attaching step is started at a short time interval after the white ink attaching step is completed. In addition, since continuous printing can be stably performed with respect to textile printing by using an ink jet method in accordance with the ink composition, an image having favorable color developability, washing fastness, and rubbing fastness can be formed on the fabric at higher speed.

The time elapsed from completion of the white ink attaching step until start of the non-white textile printing ink attaching step is preferably within 50 sec, more preferably within 40 sec, and further preferably within 30 sec. According to the recording method, an image having favorable color developability, washing fastness, and rubbing fastness can be formed regardless of such a short time interval.

### 5.3.4. Configuration of Ink Jet Recording Apparatus

In the recording method, the non-white textile printing ink attaching step can be started at a short time interval after the white ink attaching step is completed. Such a time interval may be realized by appropriately setting the arrangement of the recording head, the scanning speed, the transportation speed of the fabric, and the like of the adopted ink jet recording apparatus.

For example, setting the distance between the downstream end portion, in the fabric transport direction, of the recording head nozzle for ejecting the white ink and the upstream end portion, in the fabric transport direction, of the recording head nozzle for ejecting the non-white textile printing ink to be 200 mm and adjusting the scanning speed of the recording head, the number of passes of recording, and the like so that the feed speed of the fabric is set to be 20 mm/s enable the time elapsed from completion of the white ink attaching step until start of the non-white textile printing ink attaching step to become 20 sec.

### 5.3.5. Other Steps

As the situation demands, the recording method may further include a step of attaching at least one of other white ink jet ink compositions and other non-white textile printing ink jet ink compositions to the recording medium. In such an instance, there is no limitation regarding the order and the number of these steps, and the steps can be appropriately performed as the situation demands. Further, the ink jet recording method may include a treatment liquid composition attaching step, a recording medium heating step (after-heating step), and the like.

### 5.3.5.1. Treatment Liquid Composition Attaching Step

The recording method may include a treatment liquid composition attaching step of attaching a treatment liquid composition to the fabric. The treatment liquid composition attaching step is a step of attaching the treatment liquid composition to the fabric before the white ink attaching step. In this regard, the treatment liquid composition attaching step may refer to the above description.

The amount of the treatment liquid composition attached to the fabric is, for example, preferably 0.02 g/cm² or more and 0.5 g/cm² or less and more preferably 0.02 g/cm² or more and 0.3 g/cm² or less. The amount of the treatment liquid composition attached being within the above-described range enables the treatment liquid composition to be more uniformly attached to the fabric, enables aggregation variations in an image on the textile-printed material to be further suppressed from occurring, and enables the color development to be enhanced.

Examples of the method for attaching the treatment liquid composition to the fabric include a dip coating method in which the fabric is dipped in the treatment liquid composition, a roller coating method in which the treatment liquid composition is applied using a mangle roller, roll coater, or the like, a spray coating method in which the treatment liquid composition is sprayed using a splaying apparatus or the like, and an ink jet coating method in which the treatment liquid composition is ejected by an ink jet method. Regarding these coating methods, one method may be used alone so as to attach the treatment liquid composition to the fabric, or at least two methods may be used in combination so as to attach the treatment liquid composition to the fabric.

The present step may be performed by coating, dipping, or the like or may be performed using the same apparatus as the ink jet recording apparatus for performing the white ink attaching step. In such an instance, the treatment liquid composition is set to be ejected from a nozzle different from the nozzles for ejecting the white ink and non-white textile printing ink of the recording head.

In the present step, as the situation demands, the fabric to which the treatment liquid composition is attached may be heated and dried. The drying method may refer to the above-described heating step.

### 5.3.5.2. After-Heating Step

The recording method may further include an after-heating step of heating the fabric after the non-white textile printing ink attaching step. The after-heating step is also referred to as a secondary heating step. The after-heating step can be performed using, for example, an appropriate heating device. Alternatively, heat pressing or the like may be used. Since the resulting image can be dried and more sufficiently fixed, for example, the recorded material can rapidly take on a ready-to-use state.

### EXAMPLES

The present disclosure will be described below in detail with reference to the examples, but the present disclosure is not limited to these. Hereafter, “part” represents “part by mass” unless otherwise specified.

### 1. Non-White Textile Printing Ink Jet Ink Composition and White Ink Jet Ink Composition

### 1.1. Preparation of Ink Composition

### Examples 1 to 4, Comparative Examples 1 to 6, and Reference Examples 1 to 3

Each component was placed in a container in accordance with compositions of the non-white textile printing ink jet ink compositions presented in Table 1 and the white ink jet ink compositions presented in Table 2, and mixing and agitation were performed for 2 hours by using a magnetic stirrer. Further, sufficient mixing was performed through dispersion treatment in a beads mill filled with zirconia beads having a diameter of 0.3 mm. After agitation was performed for 1 hour, filtration was performed using a 5.0-μm PTFE membrane filter so as to obtain inks according to the examples, the comparative examples, and the reference examples. The numerical values in Table 1 and Table 2 are expressed in % by mass. Ion-exchanged water was used as the water and was added so that the mass of each ink was set to be 100% by mass.

In this regard, each component presented in Table 1 and Table 2 is as described below.

### Pigment

Carbon Black Dispersion

Regarding a pigment, MICROJET CW1 (trade name, specific gravity: 1.8 g/mL or more and 1.9 g/mL or less) (Orient Chemical Industries, Ltd.) was used, and regarding the pigment dispersing agent, an anionic resin dispersing agent was used. Specifically, a styrene-acrylic resin synthesized using 55% by mass of styrene, 20% by mass of acrylic acid, and 30% by mass of methyl methacrylate was used. A carbon black dispersion was obtained by mixing 3 parts by mass of the pigment with 1 part by mass of the dispersing agent and 10 parts by mass of the ion-exchanged water, subjecting the resulting mixture to pre-mixing, performing dispersion by using a beads mill dispersing machine (UAM-015 produced by Kotobuki Industries Co., Ltd.) with zirconia beads having a diameter of 0.03 mm at a circumferential velocity of 10 m/s and a liquid temperature of 30° C. for 15 min, and centrifugally separating coarse particles by using a centrifuge (Model-3600 produced by KUBOTA CORPORATION).

Titanium Oxide Dispersion

A titanium oxide dispersion was obtained by a method akin to that for the above-described carbon black dispersion except that C.I. Pigment White 6 (specific gravity: 4.2 g/mL) instead of MICROJET CW1 (trade name) was used.

### Resin Dispersion

TAKELAC (registered trademark) WS-6021 (trade name, produced by Mitsui Chemicals, Inc.), urethane-based resin particle

### Humectant (Organic Solvent)

Glycerin

### Organic Solvent

Triethylene glycol

Triethylene glycol monobutyl ether

Propylene glycol

### Surfactant

BYK (registered trademark)-348 (trade name, produced by BYK Japan KK, HLB value: 11, polyether-modified organosiloxane surfactant)

Surfynol (registered trademark) 104 (trade name, produced by Nisshin Chemical Industry Co., Ltd.), HLB value: 4, acetylene-glycol-based surfactant (2,4,7,9-tetramethyl-5-decyne-4,7-diol)

Surfynol (registered trademark) SE (trade name, produced by Nisshin Chemical Industry Co., Ltd.), HLB value: 6, acetylene-glycol-based surfactant (containing 2,4,7,9-tetramethyl-5-decyne-4,7-diol and 2,4,7,9-tetramethyl decyne-4,7-diol ethylene oxide adduct)

Surfynol (registered trademark) 440 (trade name, produced by Nisshin Chemical Industry Co., Ltd.), HLB value: 8, acetylene-glycol-based surfactant (2,4,7,9-tetramethyl decyne-4,7-diol ethylene oxide adduct)

Surfynol (registered trademark) 485 (trade name, produced by Nisshin Chemical Industry Co., Ltd.), HLB value: 13, acetylene-glycol-based surfactant (2,4,7,9-tetramethyl-5-decyne-4,7-diol ethylene oxide adduct, the number of moles of ethylene oxide added: 30)

F-444 (trade name, produced by DIC Corporation), HLB value: 8.5, fluorine-based surfactant

TABLE 1

| | | | Comparative | Comparative | | | Comparative |
|---|---|---|---|---|---|---|---|
| | | | example 1 | example 2 | Example 1 | Example 2 | example 3 |
| Non-white | Pigment | carbon black | 3 | 3 | 3 | 3 | 3 |
| textile | | dispersion | | | | | |
| printing | Resin | TAKELAC | 4 | 4 | 4 | 4 | 4 |
| ink jet ink | dispersion | WS-6021 | | | | | |
| composition | Humectant | glycerin | 10 | 10 | 10 | 10 | 10 |
| (% by mass) | (organic solvent) | | | | | | |
| | Organic solvent | triethylene glycol | 5 | 5 | 5 | 5 | 5 |
| | | triethylene glycol | 1 | 1 | 1 | 1 | 1 |
| | | monobutyl ether | | | | | |
| | | propylene glycol | 2 | 2 | 2 | 2 | 2 |
| | Surfactant | BYK-348 (HLB: 11, | 1 | | | | |
| | | silicone-based) | | | | | |
| | | Surfynol 104 (HLB: 4, | | 1 | | | |
| | | acetylene-based) | | | | | |
| | | Surfynol SE (HLB: 6, | | | 1 | | |
| | | acetylene-based) | | | | | |
| | | Surfynol 440 (HLB: 8, | | | | 1 | |
| | | acetylene-based) | | | | | |
| | | Surfynol 485 (HLB: 13, | | | | | 1 |
| | | acetylene-based) | | | | | |
| | | F-444 (HLB: 8.5, | | | | | |
| | | fluorine-based) | | | | | |
| | Pure water | | rest | rest | rest | rest | rest |
| | | | Comparative | Comparative | | | Comparative |
| | | | example 4 | example 5 | Example 3 | Example 4 | example 6 |
| Non-white | Pigment | carbon black | 3 | 3 | 3 | 3 | 3 |
| textile | | dispersion | | | | | |
| printing | Resin | TAKELAC | 4 | 4 | 4 | 4 | 4 |
| ink jet ink | dispersion | WS-6021 | | | | | |
| composition | Humectant | glycerin | 10 | 10 | 10 | 10 | 10 |
| (% by mass) | (organic solvent) | | | | | | |
| | Organic solvent | triethylene glycol | 5 | 5 | 5 | 5 | 5 |
| | | triethylene glycol | 1 | 1 | 1 | 1 | 1 |
| | | monobutyl ether | | | | | |
| | | propylene glycol | 2 | 2 | 2 | 2 | 2 |
| | Surfactant | BYK-348 (HLB: 11, | | | | | |
| | | silicone-based) | | | | | |
| | | Surfynol 104 (HLB: 4, | | | | | |
| | | acetylene-based) | | | | | |
| | | Surfynol SE (HLB: 6, | | | | | |
| | | acetylene-based) | | | | | |
| | | Surfynol 440 (HLB: 8, | | 0.3 | 0.5 | 2 | 2.2 |
| | | acetylene-based) | | | | | |
| | | Surfynol 485 (HLB: 13, | | | | | |
| | | acetylene-based) | | | | | |
| | | F-444 (HLB: 8.5, | 1 | | | | |
| | | fluorine-based) | | | | | |

| | | | | | |
|---|---|---|---|---|---|
| Pure water | rest | rest | rest | rest | rest |

TABLE 2

| | | | Reference | Reference | Reference |
|---|---|---|---|---|---|
| | | | example 1 | example 2 | example 3 |
| White ink | Pigment | titanium oxide | 10 | 10 | 10 |
| jet ink | | dispersion | | | |
| composition | Resin dispersion | TAKELAC WS-6021 | 10 | 10 | 10 |
| (% by mass) | Humectant | Glycerin | 10 | 10 | 10 |
| | (organic solvent) | | | | |
| | Organic solvent | triethylene glycol | 5 | 5 | 5 |
| | | triethylene glycol | 1 | 1 | 1 |
| | | monobutyl ether | | | |
| | | propylene glycol | 2 | 2 | 2 |
| | Surfactant | BYK-348 (HLB: 11, | 1 | | |
| | | silicone-based) | | | |
| | | Surfynol SE (HLB: 6, | | 1 | |
| | | acetylene-based) | | | |
| | | Surfynol 440 (HLB: 8, | | | 1 |
| | | acetylene-based | | | |

| | | | |
|---|---|---|---|
| Pure water | rest | rest | rest |

### 2. Production of Textile-Printed Material

### 2.1. Fabric

Regarding the fabric, four types of commercially available T-shirt cloths below were prepared.

White cotton T-shirt 1 (Printstar 085CVT produced by TOMS Co., Ltd.)

White cotton T-shirt 2 (Fruit of the loom Heavy HP cotton produced by TOMS Co., Ltd.)

Black cotton T-shirt 1 (Printstar 085CVT produced by TOMS Co., Ltd.)

Black cotton T-shirt 2 (Fruit of the loom Heavy HP cotton produced by TOMS Co., Ltd.)

### 2.2. Water Absorbency Evaluation of Fabric

The water absorbency (unit: sec) of each of the fabrics of the white cotton T-shirts 1 and 2 and black cotton T-shirts 1 and 2 was evaluated based on the following evaluation method. The evaluation results are presented in Table 3.

### Water Absorbency Evaluation

Initially, each of the white cotton T-shirts 1 and 2 and black cotton T-shirts 1 and 2 was cut into a test fabric 2 cm square (2 cm×2 cm).

Subsequently, the test fabric cut into 2 cm square was mounted on a water surface in a glass bottle (Screw Tube Bottle produced by Maruemu Corporation) which had a volume of 50 mL and in which 30 mL of pure water was introduced so that a height from a bottom to the water surface was 4 cm, a fabric surface being set to be parallel to the water surface. A time (sec) required of the test fabric from being mounted until reaching the glass bottle was denoted as water absorbency. In this regard, the time elapsed until reaching the bottle was specified to be a time elapsed from the fabric being mounted until a portion of the fabric reaching the bottom of the glass bottle. The time elapsed until reaching the bottle being smaller means that the fabric has higher water absorbency.

TABLE 3

| | | Water |
|---|---|---|
| | | absorbency (sec) |
| White cotton | Printstar | 8 |
| T-shirt 1 | | |
| White cotton | Fruit of | >180 |
| T-shirt 2 | the loom | |
| Black cotton | Printstar | 8 |
| T-shirt 1 | | |
| Black cotton | Fruit of | >180 |
| T-shirt 2 | the loom | |

### 2.3. Textile Printing 1

2.3.1. Textile Printing 1 (without Attachment of Treatment Liquid Composition to Fabric)

### Examples 1 to 4 and Comparative Examples 1 to 6

The non-white textile printing ink obtained in each of Examples 1 to 4 and Comparative examples 1 to 6 was attached to each of the white cotton T-shirts 1 and 2 by an ink jet method in which an ink jet printer (SC-F2000 modified machine produced by Seiko Epson Corporation) was used so as to textile-print an image. In this regard, the amount of the ink applied was set to be 30 ng/dot, and the number of nozzles was set to be 360 nozzles/line×1 line. In addition, the textile printing pattern (image) was a solid pattern with a duty of 10% or more and 100% or less, the resolution was 1,440×720 dpi, the printing range was an A4 size, and the number of printing times was once. The evaluation was performed in an environment at a temperature of 25.0° C. and a relative humidity of 40.0% until the application of the ink was completed. That is, the temperature of the fabric surface vicinity was substantially equal to the environmental temperature. Specifically, the temperature was 28.0° C. or lower.

The image after textile printing was dried using a heat press drier (AF-54TEN (trade name) produced by Asahi Garment Machinery Co., Ltd., lower iron dimension of 500 mm×400 mm) under the conditions of 170° C., 60 sec, and 4.5 kN so as to obtain a textile-printed material of each of Examples 1 to 4 and Comparative examples of 1 to 6.

2.3.2. Textile Printing 2 (with Attachment of Treatment Liquid Composition to Fabric)

### Reference Examples 1 to 3

Each of the black cotton T-shirts 1 and 2 was coated with 20 g of a treatment liquid composition below by an ink jet method in which an ink jet printer (SC-F2000 modified machine produced by Seiko Epson Corporation) was used. In this regard, the range of the treatment liquid composition applied was set to be an A4 size. Thereafter, drying was performed using a heat press drier (AF-54TEN (trade name) produced by Asahi Garment Machinery Co., Ltd., lower iron dimension of 500 mm×400 mm) under the conditions of 170° C., 45 sec, and 4.5 kN so as to obtain a black cotton T-shirt to which the treatment liquid composition was attached.

### Treatment Liquid Composition

Polyvalent metal salt: calcium nitrate tetrahydrate, 5% by mass, produced by KANTO CHEMICAL CO., INC.

Resin dispersion liquid: Vinyblan (registered trademark) 1245L (trade name, solid content of 40%), 1% by mass (in terms of solid content), produced by Japan Coating Resin Corporation, acrylic copolymer aqueous emulsion

Surfactant: OLFIN (registered trademark) E1010 (trade name, HLB value: 13 or more and 14 or less), 0.1% by mass, produced by Nisshin Chemical Industry Co., Ltd., acetylene-based surfactant

Solvent: ion-exchanged water, rest

The black cotton T-shirt 1 or the black cotton T-shirt 2 to which the treatment liquid composition was attached was coated with the white ink obtained in each of Reference examples 1 to 3. In this regard, the amount of the ink applied was set to be 30 ng/dot, and the number of nozzles used was set to be 360 nozzles/line×4 lines. In addition, the textile printing pattern (image) was a solid pattern with a duty of 10% or more and 100% or less, the resolution was 1,440×1,440 dpi, the printing range was an A4 size, and the number of printing times was twice.

After the image was textile-printed, the image after textile printing was dried using a heat press drier (AF-54TEN (trade name) produced by Asahi Garment Machinery Co., Ltd., lower iron dimension of 500 mm×400 mm) under the conditions of 170° C., 60 sec, and 4.5 kN so as to obtain a textile-printed material of each of Reference examples 1 to 3.

2.3.3. Textile Printing 3 (with Attachment of Treatment Liquid Composition to Fabric)

### Examples 5 and 6, Comparative Examples 7 to 9, and Reference Examples 4 and 5

The black cotton T-shirt 1 to which the treatment liquid composition was attached, as described above, was coated with the white ink that was obtained in each of Reference examples 1 to 3 and that served as a lower layer, as presented in Table 4. Subsequently, as presented in Table 4, the region coated with the white ink (lower layer) was coated with the non-white textile printing ink that was obtained in each of Examples 1 and 2 and Comparative examples 1, 5, and 6 and that served as an upper layer. Each time elapsed from completion of application of the white ink until start of application of the non-white textile printing ink was set to be within 15 sec.

In this regard, the amount of the white ink applied was set to be 30 ng/dot, and the number of nozzles used was set to be 360 nozzles/line×4 lines. In addition, the textile printing pattern (image) was a solid pattern with a duty of 10% or more and 100% or less, the resolution was 1,440×1,440 dpi, the printing range was an A4 size, and the number of printing times was twice.

The amount of the non-white textile printing ink applied was set to be 30 ng/dot, and the number of nozzles used was set to be 360 nozzles/line×1 line. In addition, the textile printing pattern (image) was a solid pattern with a duty of 10% or more and 100% or less, the resolution was 1,440×720 dpi, the printing range was an A4 size, and the number of printing times was once.

In this regard, the evaluation was performed in an environment at a temperature of 25.0° C. and a relative humidity of 40.0% from start of application of the white ink to completion of application of the non-white textile printing ink, while heat-drying was not performed from completion of application of the white ink to start of application of the non-white textile printing ink. That is, the temperature of the fabric surface vicinity was substantially equal to the environmental temperature from start of application of the white ink to completion of application of the non-white textile printing ink. Specifically, the temperature was 28.0° C. or lower.

After the image was textile-printed, the image after textile printing was dried using a heat press drier (AF-54TEN (trade name) produced by Asahi Garment Machinery Co., Ltd., lower iron dimension of 500 mm×400 mm) under the conditions of 170° C., 60 sec, and 4.5 kN so as to obtain a textile-printed material of each of examples 5 and 6,

### Comparative Examples 7 to 9, and Reference Examples 4 and 5

TABLE 4

| | | Comparative | | | Reference | Reference | Comparative | Comparative |
|---|---|---|---|---|---|---|---|---|
| | | example 7 | Example 5 | Example 6 | example 4 | example 5 | example 8 | example 9 |
| White ink | Ink | Reference | Reference | Reference | Reference | Reference | Reference | Reference |
| (lower layer) | composition | example 1 | example 1 | example 1 | example 2 | example 3 | example 1 | example 1 |
| | Surfactant | BYK-348 | BYK-348 | BYK-348 | Surfynol | Surfynol | BYK-348 | BYK-348 |
| | | (HLB | (HLB | (HLB | SE (HLB | 440 (HLB | (HLB | (HLB |
| | | value: 11) | value: 11) | value: 11) | value: 6) | value: 8) | value: 11) | value: 11) |
| Non-white | Ink | Comparative | Example 1 | Example 2 | Example 2 | Example 2 | Comparative | Comparative |
| textile | composition | example 1 | | | | | example 5 | example 6 |
| printing ink | Surfactant | BYK-348 | Surfynol | Surfynol | Surfynol | Surfynol | Surfynol | Surfynol |
| (upper layer) | | (HLB | SE (HLB | 440 (HLB | 440 (HLB | 440 (HLB | 440 (HLB | 440 (HLB |
| | | value: 14) | value: 6) | value: 8) | value: 8) | value: 8) | value: 8) | value: 8) |

### 3. Evaluation Method

### 3.1. Ink Surface Tension

Regarding each of the non-white textile printing inks obtained in Examples 1 to 4 and Comparative examples 1 to 6 or the white inks obtained in Reference examples 1 to 3, 20 g of the ink was placed in a glass laboratory dish, a platinum plate was made to perpendicularly come into contact, and the ink surface tension (mN/m) at normal temperature and normal pressure was measured by the Wilhelmy method in which Surface Tensiometer CBVP-Z (trade name, produced by Kyowa Interface Science Co., Ltd.). These results are presented in Table 5 and Table 6.

### 3.2. Ejection Reliability

The white cotton T-shirt 1 or the black cotton T-shirt 1 to which the treatment liquid composition was attached was continuously printed for 1 min with each of the non-white textile printing inks obtained in Examples 1 to 4 and Comparative examples 1 to 6 or each of the white inks obtained in Reference examples 1 to 3 while the ink was circulated by an ink jet method in which an ink jet printer (SC-F2000 modified machine produced by Seiko Epson Corporation) was used. In this regard, the amount of each of the white ink applied and the non-white textile printing ink applied was set to be 30 ng/dot per application. The evaluation was performed in an environment at a temperature of 25.0° C. and a relative humidity of 40.0% until application of the ink was completed. That is, the temperature of the fabric surface vicinity was substantially equal to the environmental temperature until application of the ink was completed. Specifically, the temperature was 28.0° C. or lower.

After the printing, the number of nozzles in which irregular ejection occurred was checked. The test was performed three times, and the ejection reliability was evaluated based on an average value of three times in accordance with Criteria 1 or Criteria 2 below.

### Criteria 1

A: After continuous ejection, no printing omission nor irregular printing is observed

B: After continuous ejection, printing omission and irregular printing are observed with respect to 1 or more and 2 or less nozzles

C: After continuous ejection, printing omission and irregular printing are observed with respect to 3 or more and 5 or less nozzles

D: After continuous ejection, printing omission and irregular printing are observed with respect to 6 or more nozzles

### Criteria 2

A: After continuous ejection, no printing omission nor irregular printing is observed

B: After continuous ejection, printing omission and irregular printing are observed with respect to 1 or more and 2 or less nozzles

C: After continuous ejection, printing omission and irregular printing are observed with respect to 3 or more and 4 or less nozzles

D: After continuous ejection, printing omission and irregular printing are observed with respect to 5 or more nozzles

### 3.3. Washing Fastness

Each of the textile-printed materials obtained through Textile printing 1 above in Examples 1 to 4 and Comparative examples 1 to 6, the textile-printed materials obtained through Textile printing 2 above in Reference examples 1 to 3, and the textile-printed materials obtained through Textile printing 3 above in Examples 5 and 6, Comparative examples 7 to 9, and Reference examples 4 and 5 was washed using a household laundry detergent (fluorescent whitening agent free) and a household washing machine (ZABOON (trade name) produced by TOSHIBA CORPORATION). In this regard, washing was performed twice in a standard mode.

Thereafter, regarding each of portions with a duty of 10% or more and 100% or less, a color difference ΔE₀₀ denoted by the CIE DE2000 color difference formula between before and after washing was calculated, and a maximum value thereof was specified to be ΔE₀₀Max. The washing fastness was evaluated based on the resulting ΔE₀₀Max in accordance with the criteria described below. These results are presented in Table 5 to Table 7.

### Criteria

S: ΔE₀₀Max is less than 2.0

A: ΔE₀₀Max is 2.0 or more and less than 4.0

B: ΔE₀₀Max is 4.0 or more and less than 6.0

C: ΔE₀₀Max is 6.0 or more and less than 8.0

D: ΔE₀₀Max is 8.0 or more

### 3.4. Color Developability

Regarding each of the textile-printed materials obtained through Textile printing 1 above in Examples 1 to 4 and Comparative examples 1 to 6, the textile-printed materials obtained through Textile printing 2 above in Reference examples 1 to 3, and the textile-printed materials obtained through Textile printing 3 above in Examples 5 and 6, Comparative examples 7 to 9, and Reference examples 4 and 5, the L*a*b* and the OD_{Black} value were measured using a fluorescent spectrodensitometer (FD-7 (trade name) produced by KONICA MINOLTA, INC.). The color developability was evaluated based on the resulting value in accordance with Criteria 1 or Criteria 2 below. These results are presented in Table 5 to Table 7.

### Criteria 1

S: OD_{Black} value is 1.31 or more

A: OD_{Black} value is 1.21 or more and less than 1.31

B: OD_{Black} value is 1.11 or more and less than 1.21

C: OD_{Black} value is 1.01 or more and less than 1.11

D: OD_{Black} value is less than 1.01

### Criteria 2

S: L* value is 96 or more

A: L* value is 93 or more and less than 96

B: L* value is 91 or more and less than 93

C: L* value is 88 or more and less than 91

D: L* value is less than 88

### 3.5. Image Quality (Bleeding)

The white cotton T-shirts 1 and 2 and the black cotton T-shirts 1 and 2 to which the treatment liquid composition was attached were textile-printed with a line pattern by an ink jet method in which an ink jet printer (SC-F2000 modified machine produced by Seiko Epson Corporation) was used so as to attach each of the non-white textile printing inks obtained in Examples 1 to 4 and Comparative examples 1 to 6 or each of the white inks obtained in Reference examples 1 to 3. In this regard, the line pattern was formed by textile-printing a longitudinal line, a lateral line (a line perpendicular to the longitudinal direction), a left oblique line (a line at 45° relative to the longitudinal direction in a left oblique direction), and a right oblique line (a line at 45° relative to the longitudinal direction in a right oblique direction), each having a line width of 0.5 mm or 1.0 mm. In addition, the amount of the ink applied was set to be 30 ng/dot. The evaluation was performed in an environment at a temperature of 25.0° C. and a relative humidity of 40.0% until application of the ink was completed. That is, the temperature of the fabric surface vicinity was substantially equal to the environmental temperature until application of the ink was completed. Specifically, the temperature was 28.0° C. or lower.

After the line pattern was textile-printed, the line pattern after textile printing was dried using a heat press drier (AF-54TEN (trade name) produced by Asahi Garment Machinery Co., Ltd., lower iron dimension of 500 mm×400 mm) under the conditions of 170° C., 60 sec, and 4.5 kN so as to obtain each textile-printed material.

Regarding the longitudinal, lateral, and oblique lines of the resulting textile-printed material, bleeding ranges of their boundary portions were observed using an optical microscope, the maximum value of the bleeding range was measured, and the image quality was evaluated in accordance with the following criteria. These results are presented in Table 5 or Table 6.

### Criteria

A: bleeding range at a color boundary is less than 0.6 mm

B: bleeding range at a color boundary is 0.6 mm or more and less than 1.1 mm

C: bleeding range at a color boundary is more than 1.1 mm

### 3.6. Rubbing Fastness

The rubbing fastness of each of the textile-printed materials obtained through Textile printing 3 above in Examples 5 and 6, Comparative examples 7 to 9, and Reference examples of 4 and 5 was evaluated in conformity with the dry test or the wet test specified in JIS L 0849 “Test methods for color fastness to rubbing” and in accordance with Criteria of dry rubbing or Criteria of wet rubbing. In this regard, the test was performed by the clockmeter method. Evaluation was performed by determining the staining class by a visual appreciation method based on JIS L 0801 Article 10 (Determination of color fastness) to which JIS L 0849 refers. These results are presented in Table 7.

### Criteria of Dry Rubbing

S: rubbing fastness is 3-4 class (intermediate class) or higher and class 4 or lower

A: rubbing fastness is 2-3 class (intermediate class) or higher and class 3 or lower

B: rubbing fastness is 1-2 class (intermediate class) or higher and class 2 or lower

C: rubbing fastness is class 1 or lower Criteria of wet rubbing

S: rubbing fastness is 3-4 class (intermediate class) or higher and class 4 or lower

A: rubbing fastness is 2-3 class (intermediate class) or higher and class 3 or lower

B: rubbing fastness is 1-2 class (intermediate class) or higher and class 2 or lower

C: rubbing fastness is class 1 or lower

TABLE 5

| | | Compar- | Compar- | | | Compar- | Compar- | Compar- | | | Compar- |
|---|---|---|---|---|---|---|---|---|---|---|---|
| | | ative | ative | | | ative | ative | ative | | | ative |
| Non-white textile printing ink | | example 1 | example 2 | Example 1 | Example 2 | example 3 | example 4 | example 5 | Example 3 | Example 4 | example 6 |
| Ink surface tension (mN/m) | | 25 | 30 | 30 | 30 | 33 | 18 | 32 | 32 | 32 | 28 |
| Ejection reliability (Criteria 1) | | B | C | A | A | A | C | A | A | A | A |
| Washing | White cotton | B | A | A | A | A | A | B | A | A | A |
| fastness | T-shirt 1 | | | | | | | | | | |
| | White cotton | C | B | A | A | C | A | C | B | A | A |
| | T-shirt 2 | | | | | | | | | | |
| Color | White cotton | B | B | B | B | B | B | A | A | B | C |
| developability | T-shirt 1 | | | | | | | | | | |
| (OD_{Black}) | White cotton | C | B | B | A | C | B | B | A | B | C |
| | T-shirt 2 | | | | | | | | | | |
| Bleeding | White cotton | B | A | A | A | A | B | B | B | A | A |
| | T-shirt 1 | | | | | | | | | | |
| | White cotton | C | A | A | A | C | B | C | B | A | A |
| | T-shirt 2 | | | | | | | | | | |

TABLE 6

| | | Reference | Reference | Reference |
|---|---|---|---|---|
| White ink | | example 1 | example 2 | example 3 |
| Ink surface tension (mN/m) | | 25 | 30 | 30 |
| Ejection reliability (Criteria 2) | | A | A | A |
| Washing | Black cotton | A | A | A |
| fastness | T-shirt 1 | | | |
| | Black cotton | A | A | A |
| | T-shirt 2 | | | |
| Color | Black cotton | A | C | C |
| developability | T-shirt 1 | | | |
| (L*) | Black cotton | A | C | C |
| | T-shirt 2 | | | |
| Bleeding | Black cotton | A | A | A |
| | T-shirt 1 | | | |
| | Black cotton | A | A | A |
| | T-shirt 2 | | | |

TABLE 7

| | | Comparative | | | Reference | Reference | Comparative | Comparative |
|---|---|---|---|---|---|---|---|---|
| | | example 7 | Example 5 | Example 6 | example 4 | example 5 | example 8 | example 9 |
| White ink | | Reference | Reference | Reference | Reference | Reference | Reference | Reference |
| (lower layer) | | example 1 | example 1 | example 1 | example 2 | example 3 | example 1 | example 1 |
| Non-white | | Comparative | Example 1 | Example 2 | Example 2 | Example 2 | Comparative | Comparative |
| textile | | example 1 | | | | | example 5 | example 6 |
| printing ink | | | | | | | | |
| (upper layer) | | | | | | | | |
| Washing fastness | | B | A | A | S | B | C | S |
| Color | | B | A | S | C | A | B | C |
| developability | | | | | | | | |
| (OD_{Black}) | | | | | | | | |
| Rubbing | Dry | B | A | A | S | B | C | S |
| fastness | rubbing | | | | | | | |
| | Wet | B | A | A | S | B | C | S |
| | rubbing | | | | | | | |

As presented in Table 1, it was found that according to the ink composition of the present embodiment, a recoded material that has favorable color developability, washing fastness, and rubbing fastness regardless of the water absorbency of the fabric and that can suppress bleeding (bleeding between colors) from occurring can be obtained. In addition, it was found that the ink composition of the present embodiment can be stably continuously printed during textile printing by using an ink jet method.

From comparisons between Example 1 and Example 2, it was found that the ink composition containing an acetylene-based surfactant having an HLB value of 7 or more and 8 or less being used enables a recoded material that has more favorable washing fastness and rubbing fastness, that can further suppress bleeding (bleeding between colors) from occurring, and that has still more favorable color developability with respect to a fabric having low water absorbency to be obtained.

Further, from comparisons between Example 2 and Examples 3 and 4, it was found that the ink composition containing an acetylene-based surfactant having an HLB value of 7 or more and 8 or less where the content of the acetylene-based surfactant is 0.7% by mass or more and 1.5% by mass or less relative to a total amount of the ink composition being used enables a recoded material that has further favorable color developability, washing fastness, and rubbing fastness regardless of the water absorbency of the fabric and that can further suppress bleeding (bleeding between colors) from occurring to be obtained.

As presented in Table 3, it was found that according to the ink set of the present embodiment, a recoded material having favorable color developability, washing fastness, and rubbing fastness can be obtained.

In addition, from comparisons between Example 5 and Example 6, it was found that the white ink containing a silicone-based surfactant having an HLB value of 10 or more and 14 or less being textile-printed with the ink composition containing an acetylene-based surfactant having an HLB value of 7 or more and 8 or less enables a recoded material that has more favorable washing fastness and rubbing fastness and that has still more favorable color developability with respect to a fabric having low water absorbency to be obtained.

What is claimed is:

1. A non-white textile printing ink jet ink composition comprising:
a pigment;
a resin particle;
an acetylene-based surfactant having an HLB value of 6 or more and 10 or less; and
water, wherein
a content of the acetylene-based surfactant is 0.5% by mass or more and 2.0% by mass or less relative to a total amount of the ink composition, and
the ink composition is used for a fabric having water absorbency evaluated using a method described below is 1 or more,
method:
a test fabric cut into 2 cm square is mounted on a water surface in a glass bottle which has a volume of 50 mL and in which 30 mL of pure water is introduced so that a height from a bottom to the water surface is 4 cm, a fabric surface being set to be parallel to the water surface, and a time elapsed from the fabric being mounted until a portion of the fabric reaching the bottom of the glass bottle is denoted as water absorbency in seconds.

2. The ink composition according to claim 1, wherein the fabric has a light color.

3. The ink composition according to claim 1, wherein the fabric contains no cationic compound.

4. An ink set comprising:
the ink composition according to claim 1; and
a white ink jet ink composition, wherein
the white ink jet ink composition contains
a white pigment,
a resin particle,
a silicone-based surfactant having an HLB value of 10 or more and 14 or less, and
water.

5. An ink jet recording method comprising:
using the ink composition according to claim 1.

6. The ink jet recording method according to claim 5, wherein
ejecting of the ink composition from an ink jet head so as to attach the ink composition to the fabric by using an ink jet method is included.
